(19) United States
(12) Patent Application Publication
(10) Pub. No.: US 2024/0048350 A1
(43) Pub. Date: Feb. 8, 2024

(54) SUB-BANDWIDTH PART CONFIGURATIONS FOR HALF-DUPLEX AND FULL-DUPLEX COMMUNICATIONS

(71) Applicant: QUALCOMM INCORPORATED, San Diego, CA (US)

(72) Inventors: Abdelrahman Mohamed Ahmed Mohamed IBRAHIM, San Diego, CA (US); Linhai HE, San Diego, CA (US); Ruiming ZHENG, Beijing (CN); Muhammad Sayed Khairy ABDELGHAFFAR, San Jose, CA (US); Ahmed Attia ABOTABL, San Diego, CA (US); Wanshi CHEN, San Diego, CA (US); Hwan Joon KWON, San Diego, CA (US); Krishna Kiran MUKKAVILLI, San Diego, CA (US)

(21) Appl. No.: 18/258,500

(22) PCT Filed: Feb. 18, 2022
(86) PCT No.: PCT/CN2022/076776

§ 371 Date: Jun. 20, 2023

(30) Foreign Application Priority Data
Mar. 4, 2021 (WO) PCT/CN2021/079027

(51) Int. Cl. H04L 5/16; H04W 72/0453

(52) U.S. Cl. CPC H04L 5/16; H04W 72/0453

(57) ABSTRACT

Methods, systems, and devices for wireless communications are described. A user equipment (UE) may receive, from a base station, control signaling indicating a set of sub-bandwidth part (BWP) channel configurations for wireless communications at the UE, where each sub-BWP channel configuration of the set of sub-BWP channel configurations may include one or more sets of resources spanning at least a portion of a respective BWP in the frequency domain. The UE may receive, from the base station, a control message indicating a first sub-BWP channel configuration of the set of sub-BWP channel configurations, the first sub-BWP channel configuration supporting wireless communication for a full-duplex communication mode and a half-duplex communication mode. The UE may communicate with the base station during a first transmission time interval (TTI) using the first sub-BWP channel configuration indicated via the control message and based on the full-duplex communication mode or the half-duplex communication mode.

### CROSS REFERENCES

The present application is a 371 national stage filing of International PCT Application No. PCT/CN2022/076776 by IBRAHIM et al. entitled “SUB-BANDWIDTH PART CONFIGURATIONS FOR HALF-DUPLEX AND FULL-DUPLEX COMMUNICATIONS,” filed Feb. 18, 2022; and claims priority to International Patent Application No. PCT/CN2021/079027 by IBRAHIM et al. entitled “TECHNIQUES FOR SUB-BANDWIDTH PART CONFIGURATIONS,” filed Mar. 4, 2021, each of which is assigned to the assignee hereof, and each of which is expressly incorporated by reference in its entirety herein.

### FIELD OF TECHNOLOGY

The following relates to wireless communications, including techniques for sub-bandwidth part (BWP) configurations usable for half-duplex and full-duplex communications.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications devices (for example, UEs) may be configured to perform both half-duplex wireless communications and full-duplex wireless communications. To perform wireless communications, UEs may be configured with bandwidth part (BWP) channel configurations defining formats or arrangements of communication resources (e.g., BWPs) in which wireless communications are to be performed. When configuring BWP channel configurations for wireless communications at a UE, communications systems may attempt to use mode-specific BWP channel configurations (e.g., BWP channel configurations dedicated to either a half-duplex mode or a full-duplex mode), or non-mode-specific BWP channel configurations (e.g., BWP channel configurations that are not dedicated to either a half-duplex mode or a full-duplex mode). With the mode-specific BWP channel configurations, a UE may perform BWP switching each time the UE switches between the half-duplex communication mode and the full-duplex communication mode, which may increase latency and processing power. While the non-mode-specific BWP channel configurations don't require BWP switching when the UE switches between the half-duplex communication mode and the full-duplex communication mode, some such BWP channel configurations may not be well-suited for both full-duplex communications and half-duplex communications, which may result in less efficient use of resources.

### SUMMARY

The systems, methods and devices of this disclosure each have several innovative aspects, no single one of which is solely responsible for the desirable attributes disclosed herein.

A method for wireless communication at a user equipment (UE) is described. The method may include receiving, from a base station, control signaling indicating a set of multiple sub-bandwidth part (BWP) channel configurations for wireless communications at the UE, where each sub-BWP channel configuration of the set of multiple sub-BWP channel configurations includes one or more sets of resources spanning at least a portion of a respective BWP in the frequency domain, receiving, from the base station, a control message indicating a first sub-BWP channel configuration of the set of multiple sub-BWP channel configurations, and communicating with the base station during a first transmission time interval (TTI) in accordance with the first sub-BWP channel configuration and in accordance with one of a full-duplex communication mode or a half-duplex communication mode.

An apparatus for wireless communication at a UE is described. The apparatus may include a processor, memory coupled with the processor, and instructions stored in the memory. The instructions may be executable by the processor to cause the apparatus to receive, from a base station, control signaling indicating a set of multiple sub-BWP channel configurations for wireless communications at the UE, where each sub-BWP channel configuration of the set of multiple sub-BWP channel configurations includes one or more sets of resources spanning at least a portion of a respective BWP in the frequency domain, receive, from the base station, a control message indicating a first sub-BWP channel configuration of the set of multiple sub-BWP channel configurations, the first sub-BWP channel configuration supporting wireless communication for a full-duplex communication mode and a half-duplex communication mode, and communicate with the base station during a first TTI using the first sub-BWP channel configuration indicated via the control message and based on the full-duplex communication mode or the half-duplex communication mode.

Another apparatus for wireless communication at a UE is described. The apparatus may include means for receiving, from a base station, control signaling indicating a set of multiple sub-BWP channel configurations for wireless communications at the UE, where each sub-BWP channel configuration of the set of multiple sub-BWP channel configurations includes one or more sets of resources spanning at least a portion of a respective BWP in the frequency domain, means for receiving, from the base station, a control message indicating a first sub-BWP channel configuration of the set of multiple sub-BWP channel configurations, the first sub-BWP channel configuration supporting wireless communication for a full-duplex communication mode and a half-duplex communication mode, and means for communicating with the base station during a first TTI using the first sub-BWP channel configuration indicated via the control message and based on the full-duplex communication mode or the half-duplex communication mode.

A non-transitory computer-readable medium storing code for wireless communication at a UE is described. The code may include instructions executable by a processor to receive, from a base station, control signaling indicating a set of multiple sub-BWP channel configurations for wireless communications at the UE, where each sub-BWP channel configuration of the set of multiple sub-BWP channel configurations includes one or more sets of resources spanning at least a portion of a respective BWP in the frequency domain, receive, from the base station, a control message indicating a first sub-BWP channel configuration of the set of multiple sub-BWP channel configurations, the first sub-BWP channel configuration supporting wireless communication for a full-duplex communication mode and a half-duplex communication mode, and communicate with the base station during a first TTI using the first sub-BWP channel configuration indicated via the control message and based on the full-duplex communication mode or the half-duplex communication mode.

Some examples of the method, apparatuses, and non-transitory computer-readable medium described herein may further include operations, features, means, or instructions for receiving, from the base station via the control signaling, a set of multiple BWP channel configurations for wireless communications at the UE, where each BWP channel configuration of the set of multiple BWP channel configurations includes one or more sets of resources spanning an entirety of the respective BWP in the frequency domain, where communicating with the base station during the first TTI may be based on receiving the set of multiple BWP channel configurations.

In some examples of the method, apparatuses, and non-transitory computer-readable medium described herein, and the method, apparatuses, and non-transitory computer-readable medium may include further operations, features, means, or instructions for receiving, from the base station, an indication to perform communications in accordance with the half-duplex communication mode and communicating with the base station during a second TTI using a BWP channel configuration of the set of multiple BWP channel configurations and in accordance with the half-duplex communication mode based on receiving the indication to perform communications in accordance with the half-duplex communication mode.

In some examples of the method, apparatuses, and non-transitory computer-readable medium described herein, at least one sub-BWP channel configuration of the set of multiple sub-BWP channel configurations includes a set of resources spanning an entirety of the respective BWP in the frequency domain.

Some examples of the method, apparatuses, and non-transitory computer-readable medium described herein may further include operations, features, means, or instructions for receiving, from the base station, a second control message indicating a second sub-BWP channel configuration of the set of multiple sub-BWP channel configurations and communicating with the base station during a second TTI using the second sub-BWP channel configuration and based on the full-duplex communication mode or the half-duplex communication mode.

Some examples of the method, apparatuses, and non-transitory computer-readable medium described herein may further include operations, features, means, or instructions for receiving, from the base station via the control signaling, an indication of a first subset of the set of multiple sub-BWP channel configurations that may be associated with downlink communications at the UE and of a second subset of the set of multiple sub-BWP channel configurations which may be associated with uplink communications at the UE, where the first subset of the set of multiple sub-BWP channel configurations, the second subset of the set of multiple sub-BWP channel configurations, or both, may be associated with the full-duplex communication mode, the half-duplex communication mode, or both.

In some examples of the method, apparatuses, and non-transitory computer-readable medium described herein, communicating with the base station during the first TTI may include operations, features, means, or instructions for receiving a first downlink transmission from the base station during the first TTI using the first sub-BWP channel configuration and based on the full-duplex communication mode and transmitting a first uplink transmission to the base station during the first TTI using a second sub-BWP channel configuration associated with uplink communications at the UE and based on the full-duplex communication mode.

Some examples of the method, apparatuses, and non-transitory computer-readable medium described herein may further include operations, features, means, or instructions for receiving an indication to switch from the first sub-BWP channel configuration to a third sub-BWP channel configuration associated with downlink communications at the UE, receiving a second downlink transmission from the base station during a second TTI using the third sub-BWP channel configuration and based on the full-duplex communication mode, and transmitting a second uplink transmission to the base station during the first TTI using the second sub-BWP channel configuration and based on the full-duplex communication mode.

In some examples of the method, apparatuses, and non-transitory computer-readable medium described herein, and the method, apparatuses, and non-transitory computer-readable medium may include further operations, features, means, or instructions for where each sub-BWP channel configuration of the set of multiple sub-BWP channel configurations includes one of a dedicated sub-BWP channel configuration, a dormant sub-BWP channel configuration, a default sub-BWP channel configuration, or a first active sub-BWP channel configuration and where each sub-BWP channel configuration of the set of multiple sub-BWP channel configurations may be associated with one of a dedicated BWP, a default BWP, or a first active BWP.

Some examples of the method, apparatuses, and non-transitory computer-readable medium described herein may further include operations, features, means, or instructions for receiving, from the base station, a radio resource control (RRC) message indicating a first active BWP channel configuration associated with the full-duplex communication mode, where communicating with the base station during the first TTI includes communicating using the first active BWP channel configuration and the full-duplex communication mode based on performing an RRC configuration procedure, performing an RRC reconfiguration procedure, or activating a secondary cell (SCell).

Some examples of the method, apparatuses, and non-transitory computer-readable medium described herein may further include operations, features, means, or instructions for receiving, from the base station via the control signaling, an indication of a first active sub-BWP channel configuration of the set of multiple sub-BWP channel configurations that may be associated with the first active BWP channel configuration, where communicating with the base station using the first active BWP channel configuration includes communicating with the base station using the first active sub-BWP channel configuration.

Some examples of the method, apparatuses, and non-transitory computer-readable medium described herein may further include operations, features, means, or instructions for communicating with the base station during a second TTI using a first active BWP channel configuration associated with the half-duplex communication mode based on an absence of an additional first active BWP channel configuration that may be associated with the full-duplex communication mode and based on performing an RRC configuration procedure, performing an RRC reconfiguration procedure, or activating an SCell.

Some examples of the method, apparatuses, and non-transitory computer-readable medium described herein may further include operations, features, means, or instructions for initiating an inactivity timer associated with the full-duplex communication mode and communicating with the base station during the first TTI using the first sub-BWP channel configuration and based on the full-duplex communication mode based on initiating the inactivity timer.

Some examples of the method, apparatuses, and non-transitory computer-readable medium described herein may further include operations, features, means, or instructions for communicating with the base station during an additional TTI before the first TTI using the half-duplex communication mode and receiving, from the base station, an indication to transition from the half-duplex communication mode to the full-duplex communication mode, where initiating the inactivity timer may be based on the indication to transition from the half-duplex communication mode to the full-duplex communication mode.

Some examples of the method, apparatuses, and non-transitory computer-readable medium described herein may further include operations, features, means, or instructions for determining an expiration of the inactivity timer based on a duration of the inactivity timer and based on an absence of communications performed in accordance with the full-duplex communication mode within the duration of the inactivity timer, transitioning from the full-duplex communication mode to the half-duplex communication mode based on the expiration of the inactivity timer, and communicating with the base station during a second TTI after the first TTI based on the half-duplex communication mode and based on transitioning from the full-duplex communication mode to the half-duplex communication mode.

In some examples of the method, apparatuses, and non-transitory computer-readable medium described herein, and the method, apparatuses, and non-transitory computer-readable medium may include further operations, features, means, or instructions for determining an expiration of an inactivity timer associated with the full-duplex communication mode and communicating with the base station during a second TTI after the first TTI using the first sub-BWP channel configuration and in accordance with the half-duplex communication mode based on the expiration of the inactivity timer, or in accordance with a second sub-BWP channel configuration and the half-duplex communication mode based on the expiration of the inactivity timer.

Some examples of the method, apparatuses, and non-transitory computer-readable medium described herein may further include operations, features, means, or instructions for transmitting, to the base station, a UE capability indication associated with the full-duplex communication mode at the UE, where receiving the control signaling, receiving the control message, communicating during the first TTI, or any combination thereof, may be based on transmitting the UE capability indication.

In some examples of the method, apparatuses, and non-transitory computer-readable medium described herein, the UE capability indication includes a first capability of the UE to perform communications according to the full-duplex communication mode, a second capability of the UE to switch between the half-duplex communication mode and the full-duplex communication mode, a third capability of the UE to perform full-duplex communications according to an inactivity timer, a fourth capability of the UE to perform full-duplex communications using a first active BWP channel configuration, a fifth capability of the UE to perform full-duplex communications using a first active sub-BWP channel configuration, or any combination thereof.

A method for wireless communication at a base station is described. The method may include transmitting, to a UE, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain, transmitting, to the UE, a control message indicating a first sub-BWP channel configuration of the set of multiple sub-BWP channel configurations, the first sub-BWP channel configuration supporting wireless communication for a full-duplex communication mode and a half-duplex communication mode, and communicating with the UE during a first TTI using the first sub-BWP channel configuration indicated via the control message and based on the full-duplex communication mode or the half-duplex communication mode.

An apparatus for wireless communication at a base station is described. The apparatus may include a processor, memory coupled with the processor, and instructions stored in the memory. The instructions may be executable by the processor to cause the apparatus to transmit, to a UE, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain, transmit, to the UE, a control message indicating a first sub-BWP channel configuration of the set of multiple sub-BWP channel configurations, the first sub-BWP channel configuration supporting wireless communication for a full-duplex communication mode and a half-duplex communication mode, and communicate with the UE during a first TTI using the first sub-BWP channel configuration indicated via the control message and based on the full-duplex communication mode or the half-duplex communication mode.

Another apparatus for wireless communication at a base station is described. The apparatus may include means for transmitting, to a UE, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain, means for transmitting, to the UE, a control message indicating a first sub-BWP channel configuration of the set of multiple sub-BWP channel configurations, the first sub-BWP channel configuration supporting wireless communication for a full-duplex communication mode and a half-duplex communication mode, and means for communicating with the UE during a first TTI using the first sub-BWP channel configuration indicated via the control message and based on the full-duplex communication mode or the half-duplex communication mode.

A non-transitory computer-readable medium storing code for wireless communication at a base station is described. The code may include instructions executable by a processor to transmit, to a UE, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain, transmit, to the UE, a control message indicating a first sub-BWP channel configuration of the set of multiple sub-BWP channel configurations, the first sub-BWP channel configuration supporting wireless communication for a full-duplex communication mode and a half-duplex communication mode, and communicate with the UE during a first TTI using the first sub-BWP channel configuration indicated via the control message and based on the full-duplex communication mode or the half-duplex communication mode.

Some examples of the method, apparatuses, and non-transitory computer-readable medium described herein may further include operations, features, means, or instructions for transmitting, to the UE via the control signaling, a set of multiple BWP channel configurations for wireless communications at the UE, where each BWP channel configuration of the set of multiple BWP channel configurations includes one or more sets of resources spanning an entirety of the respective BWP in the frequency domain, where communicating with the UE during the first TTI may be based on transmitting the set of multiple BWP channel configurations.

In some examples of the method, apparatuses, and non-transitory computer-readable medium described herein, and the method, apparatuses, and non-transitory computer-readable medium may include further operations, features, means, or instructions for transmitting, to the UE, an indication to perform communications in accordance with the half-duplex communication mode and communicating with the UE during a second TTI using a BWP channel configuration of the set of multiple BWP channel configurations and in accordance with the half-duplex communication mode based on transmitting the indication to perform communications in accordance with the half-duplex communication mode.

In some examples of the method, apparatuses, and non-transitory computer-readable medium described herein, at least one sub-BWP channel configuration of the set of multiple sub-BWP channel configurations includes a set of resources spanning an entirety of the respective BWP in the frequency domain.

Some examples of the method, apparatuses, and non-transitory computer-readable medium described herein may further include operations, features, means, or instructions for transmitting, to the UE, a second control message indicating a second sub-BWP channel configuration of the set of multiple sub-BWP channel configurations and communicating with the UE during a second TTI using the second sub-BWP channel configuration and based on the full-duplex communication mode or the half-duplex communication mode.

Some examples of the method, apparatuses, and non-transitory computer-readable medium described herein may further include operations, features, means, or instructions for transmitting, to the UE via the control signaling, an indication of a first subset of the set of multiple sub-BWP channel configurations that may be associated with downlink communications at the UE and of a second subset of the set of multiple sub-BWP channel configurations which may be associated with uplink communications at the UE, where the first subset of the set of multiple sub-BWP channel configurations, the second subset of the set of multiple sub-BWP channel configurations, or both, may be associated with the full-duplex communication mode, the half-duplex communication mode, or both.

In some examples of the method, apparatuses, and non-transitory computer-readable medium described herein, communicating with the UE during the first TTI may include operations, features, means, or instructions for transmitting a first downlink transmission to the UE during the first TTI using the first sub-BWP channel configuration and based on the full-duplex communication mode and receiving a first uplink transmission from the UE during the first TTI using a second sub-BWP channel configuration associated with uplink communications at the UE and based on the full-duplex communication mode.

Some examples of the method, apparatuses, and non-transitory computer-readable medium described herein may further include operations, features, means, or instructions for transmitting an indication to switch from the first sub-BWP channel configuration to a third sub-BWP channel configuration associated with downlink communications at the UE, transmitting a second downlink transmission to the UE during a second TTI using the third sub-BWP channel configuration and based on the full-duplex communication mode, and receiving a second uplink transmission from the UE during the first TTI using the second sub-BWP channel configuration and based on the full-duplex communication mode.

In some examples of the method, apparatuses, and non-transitory computer-readable medium described herein, and the method, apparatuses, and non-transitory computer-readable medium may include further operations, features, means, or instructions for where each sub-BWP channel configuration of the set of multiple sub-BWP channel configurations includes one of a dedicated sub-BWP channel configuration, a dormant sub-BWP channel configuration, a default sub-BWP channel configuration, or a first active sub-BWP channel configuration and where each sub-BWP channel configuration of the set of multiple sub-BWP channel configurations may be associated with one of a dedicated BWP, a default BWP, or a first active BWP.

Some examples of the method, apparatuses, and non-transitory computer-readable medium described herein may further include operations, features, means, or instructions for transmitting, to the UE, an RRC message indicating a first active BWP channel configuration associated with the full-duplex communication mode, where communicating with the UE during the first TTI includes communicating using the first active BWP channel configuration and based on with the full-duplex communication mode.

Some examples of the method, apparatuses, and non-transitory computer-readable medium described herein may further include operations, features, means, or instructions for transmitting, to the UE via the control signaling, an indication of a first active sub-BWP channel configuration of the set of multiple sub-BWP channel configurations that may be associated with the first active BWP channel configuration, where communicating with the UE using the first active BWP channel configuration includes communicating with the UE using the first active sub-BWP channel configuration.

Some examples of the method, apparatuses, and non-transitory computer-readable medium described herein may further include operations, features, means, or instructions for communicating with the UE during a second TTI using a first active BWP channel configuration associated with the half-duplex communication mode based on an absence of an additional first active BWP channel configuration that may be associated with the full-duplex communication mode.

Some examples of the method, apparatuses, and non-transitory computer-readable medium described herein may further include operations, features, means, or instructions for initiating an inactivity timer associated with the full-duplex communication mode at the UE and communicating with the UE during the first TTI using the first sub-BWP channel configuration and in accordance with the full-duplex communication mode based on initiating the inactivity timer.

Some examples of the method, apparatuses, and non-transitory computer-readable medium described herein may further include operations, features, means, or instructions for communicating with the UE during an additional TTI before the first TTI based on the half-duplex communication mode and transmitting, to the UE, an indication to transition from the half-duplex communication mode to the full-duplex communication mode, where initiating the inactivity timer may be based on the indication to transition from the half-duplex communication mode to the full-duplex communication mode.

Some examples of the method, apparatuses, and non-transitory computer-readable medium described herein may further include operations, features, means, or instructions for determining an expiration of the inactivity timer based on a duration of the inactivity timer and based on an absence of communications performed at the UE in accordance with the full-duplex communication mode within the duration of the inactivity timer and communicating with the UE during a second TTI after the first TTI in accordance with the half-duplex communication mode and based on the UE transitioning from the full-duplex communication mode to the half-duplex communication mode.

In some examples of the method, apparatuses, and non-transitory computer-readable medium described herein, and the method, apparatuses, and non-transitory computer-readable medium may include further operations, features, means, or instructions for determining an expiration of an inactivity timer associated with the full-duplex communication mode and communicating with the UE during a second TTI after the first TTI using the first sub-BWP channel configuration and in accordance with the half-duplex communication mode based on the expiration of the inactivity timer, or in accordance with a second sub-BWP channel configuration and the half-duplex communication mode based on the expiration of the inactivity timer.

Some examples of the method, apparatuses, and non-transitory computer-readable medium described herein may further include operations, features, means, or instructions for receiving, from the UE, a UE capability indication associated with the full-duplex communication mode at the UE, where transmitting the control signaling, transmitting the control message, communicating during the first TTI, or any combination thereof, may be based on receiving the UE capability indication.

In some examples of the method, apparatuses, and non-transitory computer-readable medium described herein, the UE capability indication includes a first capability of the UE to perform communications according to the full-duplex communication mode, a second capability of the UE to switch between the half-duplex communication mode and the full-duplex communication mode, a third capability of the UE to perform full-duplex communications according to an inactivity timer, a fourth capability of the UE to perform full-duplex communications using a first active BWP channel configuration, a fifth capability of the UE to perform full-duplex communications using a first active sub-BWP channel configuration, or any combination thereof.

### BRIEF DESCRIPTION OF THE DRAWINGS

FIG. 1 illustrates an example of a wireless communications system that supports techniques for sub-bandwidth part (BWP) configurations usable for half-duplex communications and full-duplex communications in accordance with aspects of the present disclosure.

FIG. 2 illustrates an example of a wireless communications system that supports techniques for sub-BWP configurations usable for half-duplex communications and full-duplex communications in accordance with aspects of the present disclosure.

FIG. 3 illustrates an example of a resource configuration that supports techniques for sub-BWP configurations usable for half-duplex communications and full-duplex communications in accordance with aspects of the present disclosure.

FIG. 4 illustrates an example of a resource configuration that supports techniques for sub-BWP configurations usable for half-duplex communications and full-duplex communications in accordance with aspects of the present disclosure.

FIGS. 5 and 6 show block diagrams of devices that support techniques for sub-BWP configurations usable for half-duplex communications and full-duplex communications in accordance with aspects of the present disclosure.

FIG. 7 shows a block diagram of a communications manager that supports techniques for sub-BWP configurations usable for half-duplex communications and full-duplex communications in accordance with aspects of the present disclosure.

FIG. 8 shows a diagram of a system including a device that supports techniques for sub-BWP configurations usable for half-duplex communications and full-duplex communications in accordance with aspects of the present disclosure.

FIGS. 9 and 10 show block diagrams of devices that support techniques for sub-BWP configurations usable for half-duplex communications and full-duplex communications in accordance with aspects of the present disclosure.

FIG. 11 shows a block diagram of a communications manager that supports techniques for sub-BWP configurations usable for half-duplex communications and full-duplex communications in accordance with aspects of the present disclosure.

FIG. 12 shows a diagram of a system including a device that supports techniques for sub-BWP configurations usable for half-duplex communications and full-duplex communications in accordance with aspects of the present disclosure.

FIG. 13-16 show flowcharts illustrating methods that support techniques for sub-BWP configurations usable for half-duplex communications and full-duplex communications in accordance with aspects of the present disclosure.

### DETAILED DESCRIPTION

Some wireless communications devices (for example, user equipments (UEs)) may be configured to perform both half-duplex and full-duplex wireless communications. In a half-duplex communication mode, the UE is configured to transmit or receive in one direction at a given time (for example, in the uplink or downlink direction). In a full-duplex communication mode, the UE is configured to transmit and receive communications concurrently (for example, simultaneously receive a downlink communication while transmitting an uplink communication).

To perform wireless communications, UEs may be configured with bandwidth part (BWP) channel configurations defining formats or arrangements of communication resources (e.g., BWPs) in which wireless communications are to be performed. When configuring BWP channel configurations for wireless communications at a UE, communications systems have attempted to use mode-specific BWP channel configurations (e.g., BWP channel configurations dedicated to either a half-duplex mode or a full-duplex mode), or non-mode-specific BWP channel configurations (e.g., BWP channel configurations that are not dedicated to either a half-duplex mode or a full-duplex mode). There may be advantages and disadvantages associated with mode-specific BWP channel configurations and non-mode-specific BWP channel configurations. Specifically, with mode-specific BWP channel configurations, the half-duplex and full-duplex communication modes are each associated with their own respective BWP channel configurations. As such, a UE may perform BWP switching each time the UE switches between the half-duplex and full-duplex communication modes, which may increase latency. Conversely, while non-mode-specific BWP channel configurations may be applied for both half-duplex and full-duplex communication modes, a UE may be configured with only a limited number of BWP channel configurations at any given time and some BWP channel configurations may not be well-suited for both full-duplex communications and half-duplex communications. As such, the use of non-mode-specific BWP channel configurations may result in relatively less efficient use of resources for half-duplex communications, full-duplex communications, or both.

Various aspects generally relate to techniques for sub-BWP channel configurations usable for half-duplex and full-duplex communications, and techniques for switching between duplexing modes in the context of sub-BWP channel configurations. Some aspects more specifically relate to techniques for configuring UEs with sub-BWP channel configurations, which the UE may use for half-duplex communication, full-duplex communications, or both. In this regard, aspects relate to techniques for non-mode-specific sub-BWP channel configurations that may be used at a UE for both a full-duplex communication mode and a half-duplex communication mode. As such, in examples of switching from a half-duplex communication mode to a full-duplex communication mode (or vice versa), the UE may continue using the same sub-BWP channel configuration, or may switch to a different sub-BWP channel configuration. For example, a UE may be configured with a set of sub-BWP channel configurations, in which each sub-BWP channel configuration includes one or more sets of resources that span at least a portion of a respective BWP configured at the UE. Subsequently, the UE may receive an indication as to which sub-BWP channel configuration, of the set of sub-BWP channel configurations, the UE is to use to perform half-duplex or full-duplex communications.

Particular aspects of the subject matter described in this disclosure may be implemented to realize one or more of the following potential advantages. The techniques employed by the described communication devices may provide benefits and enhancements to the operation of the communication devices for efficiency of both half-duplex and full-duplex communications. For example, by configuring UEs with non-mode-specific sub-BWP channel configurations, techniques described herein may enable the UEs to switch between a full-duplex communication mode and a half-duplex communication mode without performing BWP switching. Reducing, or eliminating, the performance of BWP switching by using sub-BWP channel configurations may improve data rates or may reduce latency, power consumption and processing burdens at the UEs, among other benefits. Moreover, using sub-BWP channel configurations may provide improved granularity of uplink/downlink communication resources compared to using less-granular BWP channel configurations. In particular, sub-BWP channel configurations may include multiple subsets of communication resources allocated for uplink communication, downlink communication, or both, within a single BWP, thereby providing improved granularity for performance of uplink and/or downlink communications within a BWP in the context of full-duplex communications. Accordingly, by configuring UEs with the sub-BWP channel configurations, techniques of the present disclosure may improve resource utilization in the context of both full-duplex communications and half-duplex communications.

Aspects of the disclosure are initially described in the context of wireless communications systems. Aspects of the disclosure are additionally described in the context of example resource configurations. Aspects of the disclosure are further illustrated by and described with reference to apparatus diagrams, system diagrams, and flowcharts that relate to techniques for sub-BWP configurations usable for half-duplex communications and full-duplex communications and changing duplex modes.

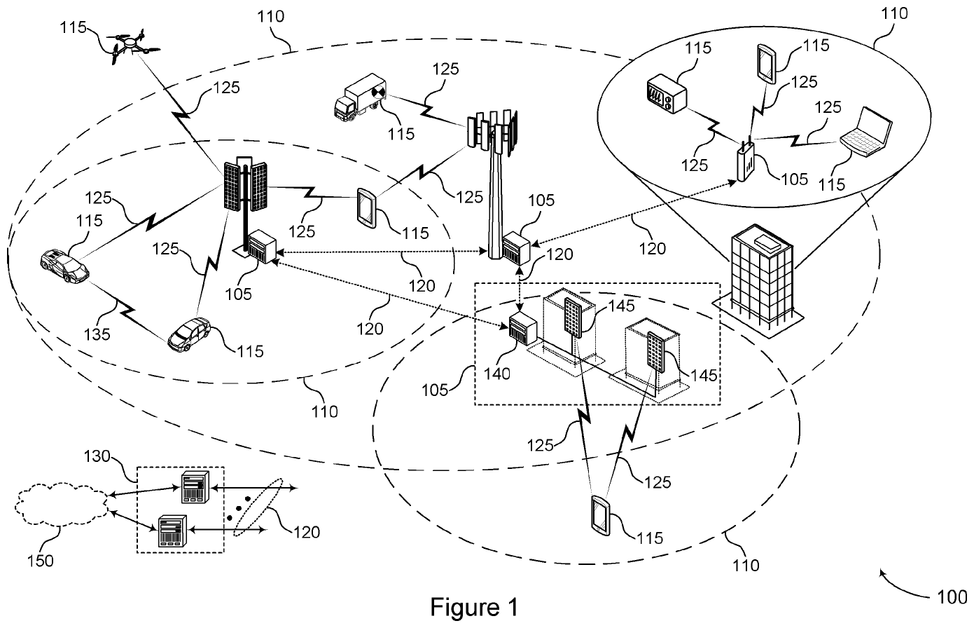

FIG. 1 illustrates an example of a wireless communications system 100 that supports techniques for sub-BWP configurations usable for half-duplex communications and full-duplex communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (for example, mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 be able to communicate with various types of devices, such as other UEs 115, the base stations 105, or network equipment (for example, core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (for example, via an S1, N2, N3, or other interface). The base stations 105 may communicate with one another over the backhaul links 120 (for example, via an X2, Xn, or other interface) either directly (for example, directly between base stations 105), or indirectly (for example, via core network 130), or both. In some examples, the backhaul links 120 may be or include one or more wireless links.

One or more of the base stations 105 may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a BWP) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (for example, in a carrier aggregation configuration), a carrier may also have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode in which initial acquisition and connection may be conducted by the UEs 115 via the carrier, or the carrier may be operated in a non-standalone mode in which a connection is anchored using a different carrier (for example, of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (for example, in an FDD mode) or may be configured to carry downlink and uplink communications (for example, in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (for example, 1.4, 3, 5, 10, 15, 20, 40, or 80 megahertz (MHz)). Devices of the wireless communications system 100 (for example, the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (for example, a duration of one modulation symbol) and one subcarrier, where the symbol period and subcarrier spacing are inversely related. The number of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some examples, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period). In some wireless communications systems 100, a slot may further be divided into multiple mini-slots containing one or more symbols. Excluding the cyclic prefix, each symbol period may contain one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, the number of symbol periods in a TTI) may be variable. Additionally or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (for example, radio heads and ANCs) or consolidated into a single network device (for example, a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. If operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (for example, a base station 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to determine (for example, by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (for example, a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (for example, by a base station 105 or a UE 115) may be performed using multiple beam directions, and the device may use a combination of digital precoding or radio frequency beamforming to generate a combined beam for transmission (for example, from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (for example, for determining a beam direction for subsequent transmission or reception by the UE 115) or for transmitting a signal in a single direction (for example, for transmitting data to a receiving device).

A receiving device (for example, a UE 115) may try multiple receive configurations (for example, directional listening) if receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, if receiving a data signal). The single receive configuration may be aligned in a beam direction determined based on listening according to different receive configuration directions (for example, a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, where the device may provide HARQ feedback in a specific slot for data received in a previous symbol in the slot. In other examples, the device may provide HARQ feedback in a subsequent slot, or according to some other time interval.

The UEs 115 and the base stations 105 of the wireless communications system 100 may support techniques for sub-BWP channel configurations and techniques for switching between duplexing modes in the context of sub-BWP channel configurations. In particular, the UEs 115 and the base stations 105 of the wireless communications system 100 may support techniques for configuring the UEs 115 with sub-BWP channel configurations, which the UEs 115 may use for half-duplex and full-duplex communications.

For example, a UE 115 may be configured with a set of sub-BWP channel configurations, in which each sub-BWP channel configuration includes sets of resources which span at least a portion of a BWP configured at the UE 115. In some implementations, some sub-BWP channel configurations may include “master” sub-BWP channel configurations which span the entirety of a respective BWP in the frequency domain. Configuring a master sub-BWP channel configuration for each respective BWP may enable improved half-duplex and other communications. Subsequently, the UE 115 may receive, from the base station 105, an indication as to which sub-BWP channel configuration is to be used, and may perform half-duplex or full-duplex communications in accordance with the indicated sub-BWP channel configuration. In some aspects, the indication as to which sub-BWP channel configuration is to be used at the UE 115 may be received via the same control signaling used to configure the set of sub-BWP channel configurations (for example, RRC signaling), a different control message (for example, a downlink control information message (DCI)), or both.

In some implementations, if switching from a half-duplex communication mode to a full-duplex communication mode (or vice versa), the UE 115 may continue using the same sub-BWP channel configuration, or may switch to a different sub-BWP channel configuration. In some aspects, RRC signaling may configure the UE 115 with first active BWP channel configurations (for example firstActiveDownlinkBWP-Id, firstActiveUplinkBWP-Id), first active sub-BWP channel configurations, or both, which are to be used following reconfiguration procedures, following the addition of SCells, or both.

In some aspects, the UE 115 may be configured with a “full-duplex inactivity timer” that may trigger the UE to transition from the full-duplex communication mode to the half-duplex communication mode to conserve power if specific conditions are met. In some aspects, the inactivity timer may be pre-configured at the UE, signaled to the UE via control signaling, or both. For example, the UE 115 may be configured to determine an expiration of the inactivity timer based on determining a duration of time without full-duplex communications, and may be configured to switch from the full-duplex communication mode to the half-duplex communication mode based on the expiration of the inactivity timer.

Techniques of the present disclosure may enable improved wireless communications in the context of full-duplex and half-duplex communications. In particular, by configuring sub-BWP channel configurations at a UE 115, techniques described herein may enable the UE 115 to switch between a full-duplex communication mode and a half-duplex communication mode without performing BWP switching. Moreover, sub-BWP channel configurations may provide improved granularity of uplink/downlink communication resources as compared to BWP channel configurations. Accordingly, by configuring UEs 115 with sub-BWP channel configurations, techniques of the present disclosure may improve resource utilization in the context of both full-duplex communications and half-duplex communications.

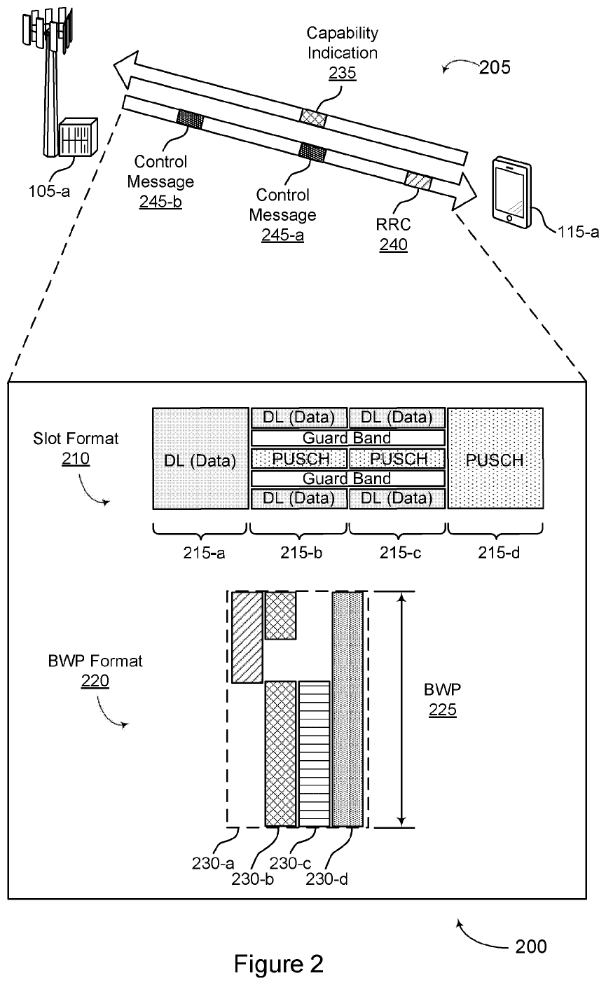

FIG. 2 illustrates an example of a wireless communications system 200 that supports techniques for sub-BWP configurations usable for half-duplex communications and full-duplex communications in accordance with aspects of the present disclosure. The wireless communications system 200 may include a UE 115-a and a base station 105-a, which may be examples of UEs 115 and base stations 105, as described with reference to FIG. 1.

The UE 115-a may communicate with the base station 105-a using a communication link 205. In some examples, the communication link 205 may include an example of an access link, such as a Uu link. The communication link 205 may include a bi-directional link that can include both uplink and downlink communication. For example, the UE 115-a may transmit uplink transmissions, such as uplink control signals or uplink data signals, to the base station 105-a using the communication link 205, and the base station 105-a may transmit downlink transmissions, such as downlink control signals or downlink data signals, to the UE 115-a using the communication link 205.

The UE 115-a and the base station 105-a may be configured to perform full-duplex communications and half-duplex communications. For example, the UE 115-a may be configured to operate in a full-duplex communication mode, a half-duplex communication mode, or both. As noted previously herein, in a half-duplex communication mode, the UE 115-a may be configured to transmit or receive in one direction at a time. In the full-duplex communication mode, the UE 115-a may be able to transmit and receive communications concurrently or simultaneously. In some aspects, full-duplex communications may enable more frequent transmission and reception opportunities for uplink and downlink communications, respectively, which may reduce a latency of wireless communications. However, full-duplex communications may be associated with higher power consumption compared to half-duplex communications. As such, the UE 115-a may be configured to operate in half-duplex communication modes to reduce power consumption.

Full-duplex communications may include in-band full-duplex (IBFD) communications and sub-band FDD (“flexible duplex,” or sub-band full-duplex (SBFD)) communications, among other examples. In the context of IBFD communications, the UE 115-a may be configured to transmit and receive communications on the same time and frequency resources. For example, the UE 115-a may be configured to receive a downlink transmission and transmit an uplink transmission, in which the downlink and uplink transmissions share a common set of time and frequency resources. That is, the sets of resources used for the downlink and uplink transmissions may partially or fully overlap in the time domain and the frequency domain. Comparatively, in the context of SBFD communications, the UE 115-a may transmit and receive communications at the same time, but using different frequency resources. For example, the UE 115-a may receive a downlink transmission and transmit an uplink transmission within the same TTI, in which the downlink and uplink transmissions utilize different sets of frequency resources. That is, the downlink and uplink transmissions may utilize common time resources, but different frequency resources. In such cases, the different sets of frequency resources used for the respective transmissions may be separated in the frequency domain by a guard band.

In some aspects, SBFD communications may be performed in accordance with one or more slot formats 210. Each slot format 210 may define resource formats (for example, uplink format, downlink format, full-duplex format) and frequency allocations for communications resources across one or more TTIs. For example, a slot format 210 illustrated in FIG. 2 may define directions of communications resources across a first slot 215-a, a second slot 215-b, a third slot 215-c, and a fourth slot 215-d. In particular, the slot format 210 may indicate one or more resource formats (for example, uplink format, downlink format, full-duplex format) associated with each slot 215, as well as a frequency resource allocation for each slot 215. In some aspects, slot format indicators (SFIs) may indicate the resource formats for each respective slot 215. In some aspects, SFIs may indicate active time and frequency resources, and may be indicated to the UE 115-a via DCI messages received from the base station 105-a (for example, DCI format 2_x, DCI format 2_0). As such, the UE 115-a may be configured to determine a resource format (downlink format, uplink format, full-duplex format) for each respective slot 215 within an active BWP based on received DCI messages.

For example, the first slot 215-a may be associated with a downlink format, and the fourth slot 215-d may be associated with an uplink format. Moreover, the second slot 215-b and the third slot 215-c may be associated with a full-duplex format. In other words, the second slot 215-b and the third slot 215-c may include resources for both downlink and uplink communications, and may be referred to as “D+U” slots 215. Each D+U slot 215 may include downlink-only symbols, uplink-only symbols, full-duplex symbols, or any combination thereof. In some aspects, downlink and uplink communications within slots 215 with a full-duplex format (D+U slots 215) may occur in overlapping frequency bands (for example, IBFD communications), or in non-overlapping, such as adjacent, bands (for example, SBFD communications). For instance, the second slot 215-b and the third slot 215-c may each include resources for downlink and uplink communications which are separated in the frequency domain. In some examples, the resources for downlink and uplink communications may be separated in the frequency domain by guard bands. In this regard, the second slot 215-b and the third slot 215-c may be configured for SBFD communications.

In some aspects, the slot format 210 may support full-duplex communications and half-duplex communications. For example, while operating in a half-duplex communication mode, the UE 115-a may be configured to either transmit uplink communications in the uplink bands of the second slot 215-b and the third slot 215-b, or receive downlink communications in the downlink bands of the second slot 215-b and the third slot 215-b. That is, the UE 115-a may be configured to perform either uplink communications or downlink communications in each of the second slot 215-b and the third slot 215-c while operating in the half-duplex communication mode. Comparatively, while operating in a full-duplex communication mode, the UE 115-a may be configured to transmit uplink communications, receive downlink communications, or both, within each of the second slot 215-b and the third slot 215-c.

Wireless communications systems may use different techniques to indicate which duplexing communication mode that the UE 115-a should use. The UE 115-a may be configured to switch between duplexing communication modes (full-duplex communication mode, half-duplex communication mode) based on BWP switching, based on slot formats (for example, slot format 210), RRC signaling, DCI messages indicating SFIs, explicit mode signaling scheduling uplink and downlink communications in the same slot 215, or any combination thereof. For example, the UE 115-a may be configured with a BWP switching pattern in which the UE 115-a is to switch between BWP channel configurations configured for full-duplex and half-duplex communications. By way of another example, RRC signaling (for example, tdd-UL-DL-ConfigurationCommon, tdd-UL-DL-ConfigurationDedicated) may configure the UE 115-a with sets of resources associated with full-duplex and half-duplex communications. Similarly, if the UE 115-a receives a DCI message scheduling both uplink and downlink communications in the same slot 215 (for example, second slot 215-b or third slot 215-c), the UE 115-a may be configured to determine that it is to transition to the full-duplex communication mode to perform the scheduled transmissions.

In some aspects, the UE 115-a may be configured with up to four BWP channel configurations at a time. Each BWP channel configuration may define a set of resources across one or more BWPs for wireless communications at the UE 115-a. For example, the base station 105-a may configure the UE 115-a with up to four active BWP channel configurations via RRC signaling. BWP channel configurations may include dedicated BWPs, default BWPs, dormant BWPs, and active BWPs (for example, first active BWPs). BWP switching for a serving cell (for example, serving cell supported by the base station 105-a) may activate an inactive BWP at the UE 115-a, and deactivate an active BWP.

In examples in which configuring BWP channel configurations for wireless communications at the UE 115-a, some communications systems have attempted to use mode-specific BWP channel configurations, non-mode-specific BWP channel configurations, or both. Each comes with its own share of advantages and disadvantages.

With mode-specific BWP channel configurations, the half-duplex and full-duplex communication modes are each associated with their own BWP channel configurations. That is, the UE 115-a may be configured with a first set of BWP channel configurations for half-duplex communications, and a second set of BWP channel configurations for full-duplex communications. As such, if configured with mode-specific BWP channel configurations, the UE 115-a may perform BWP switching each time the UE 115-a switches between the half-duplex and full-duplex communication modes. This may increase latency and may be computationally expensive.

Conversely, non-mode-specific BWP channel configurations may be decoupled from the duplexing mode such that the BWP channel configurations may be applied for both half-duplex and full-duplex communication modes. In other words, the full-duplex communication mode and the half-duplex communication mode may be associated with a common set of BWP channel configurations. Decoupling the duplexing mode from the BWP channel configurations may prevent the UE 115-a from having to perform BWP switching each time the UE 115-a switches between the full-duplex and half-duplex communication modes. Some BWP channel configurations, however, may be ill-suited for full-duplex communications or half-duplex communications. As such, non-mode-specific BWP channel configurations may result in less efficient use of resources for half-duplex communications, full-duplex communications, or both.

Accordingly, the UE 115-a and the base station 105-a of the wireless communications system 200 may support sub-BWP channel configurations 230, and techniques for switching between duplexing modes in the context of sub-BWP channel configurations 230. In particular, the wireless communications system 200 may enable the UE 115-a to be configured with a sets of non-mode specific sub-BWP channel configurations 230 and BWP channel configurations that the UE 115-a may use for both half-duplex and full-duplex communications. As is described in further detail herein, each sub-BWP channel configuration 230 may include one or more sets of resources which span at least a portion of a BWP 225 in the frequency domain.

For example, the UE 115-a may transmit a capability indication 235 to the base station 105-a via the communication link 205. The capability indication 235 may be associated with a full-duplex communication mode at the UE 115-a. That is, the capability indication 235 may indicate one or more capabilities of the UE 115-a associated with full-duplex communications at the UE 115-a. For instance, the capability indication 235 may indicate a capability of the UE 115-a to perform communications according to the full-duplex communication mode (for example, IBFD, SBFD), a capability of the UE 115-a to switch between a half-duplex communication mode and the full-duplex communication mode, or both. Additionally or alternatively, the capability indication 235 may indicate a capability of the UE 115-a to perform full-duplex communications using a first active BWP channel configuration, a first active sub-BWP channel configuration 230, or both.

Moreover, the capability indication 235 may indicate a capability of the UE 115-a to perform full-duplex communications according to an inactivity timer. For instance, the capability indication 235 may indicate a capability of the UE 115-a switch from the full-duplex communication mode to the half-duplex communication mode based on an expiration of an inactivity timer, a capability of the UE 115-a to switch between sub-BWP channel configurations 230 based on an expiration of the inactivity timer, or both. In some examples, the capability indication 235 may indicate one or more techniques that the UE 115-a may use to perform BWP switching (for example, based on BWP patterns, slot formats, RRC signaling, DCI signaling). The respective capabilities which may be indicated via the capability indication 235 will be discussed in further detail herein.

In some aspects, the UE 115-a may receive control signaling (for example, an RRC message 240, a DCI message, or other control signaling) from the base station 105-a which indicates a set of sub-BWP channel configurations 230 for wireless communications at the UE 115-a. In some implementations, the base station 105-a may configure the UE 115-a with the set of sub-BWP channel configurations 230 based on the capability indication 235. For example, the base station 105-a may transmit an RRC message 240 (control singling) which configures the UE 115-a with a set of sub-BWP channel configurations 230 in cases in which the capability indication 235 indicates that the UE 115-a is configured to communicate using sub-BWP channel configurations 230.

In some aspects, the UE 115-a may be configured with non-mode specific sub-BWP channel configurations and BWP channel configurations. That is, the UE 115-a may be configured to perform communications while operating in both the full-duplex communication mode and the half-duplex communication mode using a common set of sub-BWP channel configurations 230, BWP channel configurations, or both. In additional or alternative examples, the base station 105-a may configure the UE 115-a with sub-BWP channel configurations 230 to allow duplexing mode-specific configurations in order to support different channel and reference signal configurations for the respective duplexing modes.

The UE 115-a may be configured with a set of uplink and downlink sub-BWP channel configurations 230 within each active uplink/downlink BWP 225 configured for wireless communications at the UE 115-a. As illustrated in the BWP format 220 in FIG. 2, each sub-BWP channel configuration 230 of the set of sub-BWP channel configurations 230 may include one or more sets of resources spanning at least a portion of an active BWP 225 in the frequency domain. For example, a first sub-BWP channel configuration 230-a and a third sub-BWP channel configuration 230-c may each include one set of resources which spans a portion of the BWP 225 in the frequency domain. By way of another example, the second sub-BWP channel configuration 230-b may include two sets of resources which span a portion of the BWP 225 in the frequency domain. The UE 115-a may be configured to perform wireless communications in accordance with an active sub-BWP channel configuration 230 regardless of the active duplexing mode. In other words, the sub-BWP channel configurations 230 may be non-mode-specific such that the UE 115-a may use these in the half-duplex communication mode, the full-duplex communication mode, or both.

In some aspects, the set of sub-BWP channel configurations 230 configured at the UE 115-a via the control signaling (RRC message 240) may include at least one sub-BWP channel configuration 230 including a set of resources which spans the BWP 225 in the frequency domain. For example, as shown in the BWP format 220, the UE 115-a may be configured with a fourth sub-BWP channel configuration 230-d, in which the fourth sub-BWP channel configuration 230-d spans the entire BWP 225 in the frequency domain. That is, the bandwidth of the fourth sub-BWP channel configuration 230-d is equal to the bandwidth of the BWP 225 in the frequency domain. A sub-BWP channel configuration 230-d which spans the entire BWP 225 in the frequency domain may sometimes be referred to as a “master” sub-BWP channel configuration 230. In some aspects, configuring the UE 115-a with one or more master sub-BWP channel configurations 230 (for example, the fourth sub-BWP channel configuration 230-d) may enable improved half-duplex and other communications, such as TDD mode communications. As such, in some examples, the base station 105-a may configure the UE 115-a with solely master sub-BWP channel configurations 230 in order to be similar to a TDD mode. In some aspects, each BWP 225 associated with wireless communications at the UE 115-a may be associated with at least one master sub-BWP channel configuration 230.

In some aspects, each sub-BWP channel configuration 230 of the set of sub-BWP channel configurations 230 configured at the UE 115-a may include one of a dedicated sub-BWP channel configuration 230, a dormant sub-BWP channel configuration 230, a default sub-BWP channel configuration 230, or a first active BWP part channel configuration 230. Moreover, each sub-BWP channel configuration 230 may be associated with one of a dedicated BWP 225, a default BWP 225, or a first active BWP 225. Comparatively, in some examples, dormant BWPs 225 and initial BWPs 225 may not be configured with sub-BWP channel configurations 230.

In some aspects, as will be discussed in further detail herein, the UE 115-a may be configured to perform uplink and downlink communications using one or more sub-BWP channel configurations 230. In some examples, control signaling from the base station 105-a (for example, the RRC message 240) may configure the UE 115-a with subsets of sub-BWP channel configurations 230 which are used for uplink and downlink communications, respectively. For example, the RRC message 240 may indicate that the first and second sub-BWP channel configurations 230-a and 230-b are associated with uplink communications, and the third and fourth sub-BWP channel configurations 230-c and 230-d are associated with downlink communications.

Further, the UE 115-a may be configured to switch sub-BWP channel configurations 230 for uplink and downlink communications independently from one another. For example, the UE 115-a may be configured to perform downlink communications using the first sub-BWP channel configuration 230-a, and may be configured to perform uplink communications using the second sub-BWP channel configuration 230-b. In this example, the UE 115-a may be configured to switch the sub-BWP channel configurations 230 independently from one another such that the UE 115-a may switch the sub-BWP channel configuration 230 used for downlink communications without switching the sub-BWP channel configuration 230 used for uplink communications, and vice versa.

In some aspects, in addition to being configured with a set of sub-BWP channel configurations 230, the UE 115-a may additionally be configured with one or more BWP channel configurations. For example, the UE 115-a may receive, from the base station 105-a, control signaling which indicates a set of BWP channel configurations for wireless communications at the UE 115-a. For instance, in some examples, the RRC message 240 may configure the UE 115-a with both a set of sub-BWP channel configurations 230 and a set of BWP channel configurations. Each BWP channel configuration may include one or more sets of resources which span the entire BWP 225 in the frequency domain. In this regard, as compared to sub-BWP channel configurations 230 which include sets of resources which span at least a portion of the BWP 225, each BWP channel configuration may span the entirety of the BWP 225 in the frequency domain. In some implementations, the UE 115-a may be configured with one or more BWP channel configurations instead of being configured with one or more master sub-BWP channel configurations 230.

The UE 115-a may be configured with first active BWP channel configurations 230 associated with the half-duplex communication mode, the full-duplex communication mode, or both. In some aspects, downlink BWP channel configurations and uplink BWP channel configurations may be indicated via firstActiveDownlinkBWP-Id and firstActiveUplinkBWP-Id, respectively. Such active BWP channel configurations may be configured at the UE 115-a without physical downlink control channel (PDCCH) signaling or other control signaling indicating a downlink assignment or uplink grant. In some aspects, the UE 115-a may be configured to perform communications using the first active BWP channel configuration upon RRC configuration (or RRC reconfiguration) for a primary-secondary cell (PSCell), upon activation of an SCell. In some implementations, if a field for firstActiveDownlinkBWP-Id or firstActiveUplinkBWP-Id is absent, the RRC configuration or RRC reconfiguration may not impose a BWP switch at the UE 115-a. Moreover, the base station 105-a may be configured to set the firstActiveDownlinkBWP-Id and firstActiveUplinkBWP-Id to the same value in order to configure the first active BWP channel configurations upon PCell change, PSCell addition, PSCell change, or any combination thereof.

Additionally, or alternatively, the UE 115-a may be configured with first active BWP channel configurations associated with the full-duplex communication mode. For example, in cases in which the UE 115-a is configured with one or more BWP channel configurations, the RRC message 240 may indicate a first active BWP channel configuration of the set of BWP channel configurations associated with the full-duplex communication mode. In this example, the UE 115-a may be configured to perform communications within the first active BWP channel configuration in the full-duplex communication mode upon initial configuration, after RRC configuration and RRC reconfiguration (for example, RRC reconfiguration with synchronization), upon activation of an SCell, or any combination thereof. Otherwise, if the UE 115-a is not configured with a first active BWP channel configuration for the full-duplex communication mode, the UE 115-a may be configured to perform communications within a first active BWP channel configuration associated with the half-duplex communication mode after RRC configuration, RRC reconfiguration, upon activation of an SCell, or any combination thereof.

In cases in which the RRC message 240 configures the UE 115-a with a first active BWP channel configuration associated with the full-duplex communication mode, the RRC message 240 may additionally configure the UE 115-a with a first active sub-BWP channel configuration 230. For example, the RRC message 240 may indicate a first active sub-BWP channel configuration 230 of the set of sub-BWP channel configurations 230 which is associated with the first active BWP channel configuration. In this example, the UE 115-a may be configured to perform communications within the first active sub-BWP channel configuration 230 of the set of sub-BWP channel configurations 230 after RRC configuration, RRC reconfiguration, upon activation of an SCell, or any combination thereof. In some aspects, if the RRC message 240 does not configure a first active sub-BWP channel configuration 230, the UE 115-a may be configured to determine that a master sub-BWP channel configuration 230 (for example, the fourth sub-BWP channel configuration 230-d) is a first active sub-BWP channel configuration 230 associated with the first active BWP channel configuration.

In some aspects, the RRC message 240 may configure the UE 115-a with an inactivity timer associated with the full-duplex communication mode. In this regard, the RRC message 240 may indicate information associated with the inactivity timer. In some aspects, the UE 115-a may use the inactivity timer to switch between the full-duplex communication mode to the half-duplex communication mode. In particular, an expiration of the inactivity timer may trigger the UE 115-a to switch from the full-duplex communication mode to the half-duplex communication mode in order to conserve power.

Information associated with the inactivity timer which may be configured via the RRC message 240 may include, but is not limited to, a duration of the inactivity timer, conditions or parameters for initiating the inactivity timer, conditions/parameters for restarting (re-initiating) the inactivity timer, and the like. Other information associated with the inactivity timer may include information regarding whether expiration of the inactivity timer triggers a switch of sub-BWP channel configurations 230, information regarding which BWP channel configurations and sub-BWP channel configurations 230 are to be used upon expiration of the inactivity timer, and the like. In additional or alternative implementations, parameters associated with the inactivity timer may be configured (for example, pre-configured) at the UE 115-a without any signaling from the base station 105-a. The use of the inactivity timer to transition between duplexing modes at the UE 115-a will be described in further detail herein.

In some aspects, the UE 115-a may receive, from the base station 105-a, a control message 245-a indicating a first sub-BWP channel configuration 230 of the set of sub-BWP channel configurations 230. In this regard, the control message 245-a may indicate which sub-BWP channel configuration 230 of the set of configured sub-BWP channel configurations 230 which is to be used for wireless communications at the UE 115-a. For example, in some examples, control signaling (for example, the RRC message 240) may configure the UE 115-a with a set of sub-BWP channel configurations 230, and the control message 245-a may be used by the UE 115-a to select which sub-BWP channel configuration 230 is to be used. In this example, the control message 245-a may include a DCI message, a MAC-CE message, or both. In other examples, the base station 105-a may configure the UE 115-a with a set of sub-BWP channel configurations 230 and indicate which sub-BWP channel configuration 230 is to be used within the same control signaling. For example, in some examples, the RRC message 240, a DCI message, or both, may configure the UE 115-a with a set of sub-BWP channel configurations 230, and indicate a first sub-BWP channel configuration 230 which to be used.

Subsequently, the UE 115-a may communicate with the base station 105-a in accordance with the indicated sub-BWP channel configuration 230 of the set of sub-BWP channel configurations 230 during a first TTI (for example, during a first slot 215). For example, in cases in which the control message 245-a indicates for the UE 115-a to use the first sub-BWP channel configuration 230-a of the set of configured sub-BWP channel configurations 230, the UE 115-a may communicate with the base station 105-a based on (in accordance with) the first sub-BWP channel configuration 230-a. In this regard, the UE 115-a may transmit uplink transmissions, receive downlink transmissions, or both, in accordance with the first sub-BWP channel configuration 230-a. Moreover, the UE 115-a may communicate with the base station 105-a during the first TTI based on the first sub-BWP channel configuration 230-a in accordance with one of the full-duplex communication mode or the half-duplex communication mode.

In some aspects, the UE 115-a may be configured to determine which sub-BWP channel configuration 230, BWP channel configuration, or both, that is to be used based on the duplexing mode at the UE 115-a. In particular, in some implementations, the UE 115-a may be configured to perform communications according to a master sub-BWP channel configuration 230 or a BWP channel configuration while operating in the half-duplex communication mode. As noted previously herein, master sub-BWP channel configurations 230 and BWP channel configurations may enable more efficient use of resources within the half-duplex communication mode. As such, the UE 115-a may be configured to utilize sub-BWP channel configurations 230 while performing communications in the full-duplex communication mode, and may be configured to utilize BWP channel configurations, master sub-BWP channel configurations 230, or both, while performing communications in the half-duplex communication mode.

For example, continuing with the example above, the UE 115-a may communicate during a first TTI in accordance with a full-duplex communication mode and in accordance with the first sub-BWP channel configuration 230-a. In this example, the UE 115-a may receive an indication to perform communications in accordance with the half-duplex communication mode (for example, via a DCI message or MAC-CE message). In this example, the UE 115-a may be configured to communicate with the base station 105-a during a second TTI using the half-duplex communication mode and in accordance with the fourth sub-BWP channel configuration 230-d or a BWP channel configuration which was configured via the control signaling (RRC message 240).

In some aspects, the base station 105-a may indicate for the UE 115-a to switch between sub-BWP channel configurations 230, to switch between a sub-BWP channel configuration 230 and a BWP channel configuration, or both. The base station 105-a may indicate for the UE 115-a to switch sub-BWP channel configurations 230 and BWP channel configurations via control signaling (for example, DCI messages, MAC-CE messages).

For example, the UE 115-a may communicate with the base station 105-a during a first TTI (first slot 215) in accordance with the first sub-BWP channel configuration 230-a. Subsequently, the UE 115-a may receive a second control message 245-b indicating the second sub-BWP channel configuration 230-b. In this regard, the second control message 245-b may indicate for the UE 115-a to switch from the first sub-BWP channel configuration 230-a to the second sub-BWP channel configuration 230-b. Accordingly, the UE 115-a may communicate with the base station 105-a during a second TTI (second slot 215) in accordance with the second sub-BWP channel configuration 230-b.

As noted previously herein, the UE 115-a may be configured to switch sub-BWP channel configurations 230 used for uplink and downlink communications independently from one another. That is, the UE 115-a may be configured to switch a sub-BWP channel configuration 230 used for uplink transmissions without switching a sub-BWP channel configuration 230 used for downlink transmissions, and vice versa.

For example, the first sub-BWP channel configuration 230-a may be associated with downlink communications at the UE 115-a, and the second sub-BWP channel configuration 230-b may be associated with uplink communications at the UE 115-a. In this example, during a first TTI, the UE 115-a may receive a first downlink transmission from the base station 105-a in accordance with the first sub-BWP channel configuration 230-a, and may transmit a first uplink transmission in accordance with the second sub-BWP channel configuration 230-b. Continuing with the same example, the UE 115-a may receive an indication (for instance, via the control message 245-b) to switch from the first sub-BWP channel configuration 230-a to the third sub-BWP channel configuration 230-c which is associated with downlink communications. Accordingly, during a second TTI, the UE 115-a may receive a second downlink transmission from the base station 105-a in accordance with the third sub-BWP channel configuration 230-c, and may transmit a second uplink transmission in accordance with the second sub-BWP channel configuration 230-b. That is, the UE 115-a may switch sub-BWP channel configurations 230 used for downlink communications between the first and second TTIs, but may not switch the sub-BWP channel configuration 230 used for uplink communications.

In some aspects, the UE 115-a may be configured to communicate with the base station 105-a based on (in accordance with) first active BWP channel configurations and first active sub-BWP channel configurations 230 which were configured via control signaling (for example, the RRC message 240) received from the base station 105-a. For example, in cases in which the RRC message 240 indicates a first active BWP channel configuration associated with the full-duplex communication mode, the UE 115-a may be configured to communicate with the base station 105-a in accordance with the first active BWP channel configuration after performing an RRC configuration procedure, an RRC reconfiguration procedure, upon activating an SCell, or any combination thereof.

For instance, the UE 115-a may communicate with the base station 105-a during a first TTI in accordance with the first sub-BWP channel configuration 230-a. In this example, the RRC message 240 may have indicated a BWP channel configuration as a first active BWP channel configuration. Subsequently, the UE 115-a may perform an RRC reconfiguration procedure, and may switch from the first sub-BWP channel configuration 230-a to the BWP channel configuration (the first active BWP channel configuration) based on performing the RRC reconfiguration procedure.

Further, in some aspects, the UE 115-a may be configured to communicate with the base station 105-a based on (in accordance with) first active sub-BWP channel configurations 230 which were configured via control signaling (for example, the RRC message 240) received from the base station 105-a. For example, as noted previously herein, the RRC message 240 may indicate a first active BWP channel configuration, and may further indicate a first active sub-BWP channel configuration 230 that is associated with the first active BWP channel configuration. In this example, the RRC message 240 may indicate that the third sub-BWP channel configuration 230-c includes a first active sub-BWP channel configuration 230. As such, the UE 115-a may be configured to communicate with the base station 105-a in accordance with the third sub-BWP channel configuration 230-c (first active sub-BWP channel configuration 230-c) after performing an RRC configuration procedure, an RRC reconfiguration procedure, upon activating an SCell, or any combination thereof.

As noted previously herein, the half-duplex communication mode and the full-duplex communication mode may be associated with (configured with) the same or different first active BWP channel configurations. In some implementations, the UE 115-a may be configured to communicate with the base station 105-a using a first active BWP channel configuration associated with the half-duplex communication mode based on an absence of a first active BWP channel configuration that is associated with the full-duplex communication mode As such, upon performing an RRC configuration procedure, RRC reconfiguration procedure, or activating an SCell, the UE 115-a may be configured to communicate with a first active BWP channel configuration that is associated with the half-duplex communication mode if it has not been configured with a first active BWP channel configuration that is associated with the full-duplex communication mode.

In some aspects, the UE 115-a may be configured to communicate with the base station 105-a in accordance with the inactivity timer (full-duplex inactivity timer), in which the inactivity timer may be configured via the RRC message 240, pre-configured at the UE 115-a, or both. The inactivity timer may trigger the UE 115-a to switch from (fall back from) the full-duplex communication mode to the half-duplex communication mode in order to reduce power consumption. In particular, the inactivity timer may define a maximum duration of time in which the UE 115-a does not perform full-duplex communications before the UE 115-a is to fall back from the full-duplex communication mode to the half-duplex communication mode.

For example, the UE 115-a may communicate with the base station 105-a in accordance with the half-duplex communication mode. Subsequently, while communicating in the half-duplex communication mode, the UE 115-a may receive the second control message 245-b indicating for the UE 115-a to communicate in accordance with the first sub-BWP channel configuration 230-a and the full-duplex communication mode. Accordingly, the UE 115-a may switch to the full-duplex communication mode, and initiate the inactivity timer associated with the full-duplex communication mode. The UE 115-a may then communicate with the base station 105-a during a first TTI in accordance with the first sub-BWP channel configuration 230-a and the full-duplex communication mode, and based on initiating the inactivity timer.

In some aspects, the UE 115-a may initiate the inactivity timer each time it switches from the half-duplex communication mode to the full-duplex communication mode. As such, the UE 115-a may initiate the inactivity timer based on signaling from the base station 105-a which indicates for the UE 115-a to switch to the full-duplex communication mode. In some aspects, the UE 115-a may determine to switch from the half-duplex communication mode to the full-duplex communication mode (and therefore initiate the inactivity timer) based on one or more trigger conditions. Trigger conditions indicating a switch of duplexing modes may include DCI messages carrying SFI, DCI messages explicitly indicating a duplexing mode switch, control messages scheduling simultaneous uplink and downlink and uplink transmissions (for example, DCI messages scheduling communications associated with the full-duplex communication mode), configured grants and semi-persistent scheduling messages scheduling communications associated with the full-duplex communication mode, or any combination thereof. In some aspects, trigger conditions for initiating the inactivity timer associated with the full-duplex communication mode may be configured via the RRC message 240 including information associated with the inactivity timer.

In some aspects, the UE 115-a may be configured to restart (re-initiate) the inactivity timer each time the UE 115-a performs full-duplex communications. In this regard, the UE 115-a may restart the inactivity timer based on communicating in accordance with the full-duplex communication mode. For example, the UE 115-a may communicate in accordance with the first sub-BWP channel configuration 230-a and in accordance with the full-duplex communication mode during a first TTI. Subsequently, the UE 115-a may perform communications in accordance with the full-duplex communication mode during a second TTI prior to expiration of the inactivity timer. In this example, the UE 115-a may restart the inactivity timer based on performing the full-duplex communications during the second TTI prior to expiration of the inactivity timer.

In some aspects, the UE 115-a may be configured to decrement (for example, shorten) the inactivity timer based on performing half-duplex communications within the duration of the inactivity timer. For example, the UE 115-a may be configured to decrement the inactivity timer at the end of a subframe associated with communications in Frequency Range 1 (FR1) if the UE 115-a performs communications in accordance with the half-duplex communication mode within the subframe. Similarly, by way of another example, the UE 115-a may be configured to decrement the inactivity timer at the end of a half-subframe associated with communications in Frequency Range 2 (FR2) if the UE 115-a performs communications in accordance with the half-duplex communication mode within the half-subframe. In this regard, the UE 115-a may be configured to decrement (shorten, reduce) the inactivity timer if it does not perform full-duplex communications within some duration of time. Parameters for decrementing the inactivity timer may be configured via the RRC message 240, pre-configured at the UE 115-a, or both.

In some aspects, the UE 115-a may be configured to switch from the full-duplex communication mode to the half-duplex communication mode (or a SBTID mode) based on an expiration of the inactivity timer. The expiration of the inactivity timer may be based on a time at which the inactivity timer was initiated (or restarted), a duration of the inactivity timer, decrements of the inactivity timer, or any combination thereof. Further, the UE 115-a may determine the expiration of the inactivity timer based on an absence of communications performed in accordance with the full-duplex communication mode within the duration of the inactivity timer.

For example, as noted previously herein, the UE 115-a may initiate the inactivity timer based on switching from the half-duplex communication mode to the full-duplex communication mode. In this example, the UE 115-a may not perform full-duplex communications for a duration of the inactivity timer. As such, the UE 115-a may determine an expiration of the inactivity timer based on the duration of the inactivity timer and based at on an absence of communications performed in accordance with the full-duplex communication mode within the duration of the inactivity timer. In this example, the UE 115-a may transition (switch) from the full-duplex communication mode to the half-duplex communication mode based on the expiration of the inactivity timer. The UE 115-a may deactivate the inactivity timer based on switching to the half-duplex communication mode, and may perform subsequent communications in accordance with the half-duplex communication mode.

In some aspects, upon expiration of the inactivity timer, the UE 115-a may be configured to continue using the same sub-BWP channel configuration 230, may be configured to switch sub-BWP channel configurations 230, switch to a BWP channel configuration, or any combination thereof. In some aspects, the behavior of the UE 115-a following expiration of the inactivity timer (for example, whether the UE 115-a is to switch sub-BWP channel configurations 230) may be configured via the RRC message 240, pre-configured at the UE 115-a, or both.

For example, in some examples, the UE 115-a may be configured to continue using the same active uplink/downlink sub-BWP channel configuration(s) 230 upon expiration of the inactivity timer. For instance, the UE 115-a may communicate in accordance with the first sub-BWP channel configuration 230 during the first TTI. In this example, the UE 115-a may determine the expiration of the inactivity timer, and switch to the half-duplex communication mode. Subsequently, during a second TTI, the UE 115-a may communicate in accordance with the first sub-BWP channel configuration 230-a and in accordance with the half-duplex communication mode based on the expiration of the inactivity timer. In other words, the UE 115-a may not be configured to switch sub-BWP channel configurations 230 upon expiration of the inactivity timer. In such cases, separate signaling from the base station 105-a may indicate for the UE 115-a to switch sub-BWP channel configurations 230.

In some other implementations, the UE 115-a may be configured to switch sub-BWP channel configurations 230 upon expiration of the inactivity timer. For instance, the UE 115-a may communicate in accordance with the first sub-BWP channel configuration 230 during the first TTI. In this example, the UE 115-a may determine the expiration of the inactivity timer, and switch to the half-duplex communication mode. Subsequently, during a second TTI, the UE 115-a may communicate in accordance with the second sub-BWP channel configuration 230-b and in accordance with the half-duplex communication mode based on the expiration of the inactivity timer. In other words, the UE 115-a may be configured to switch sub-BWP channel configurations 230 upon expiration of the inactivity timer.

In such cases, signaling from the base station 105-a (for example, the RRC message 240) may configure the UE 115-a with indices associated with the respective sub-BWP channel configurations 230 which are to be used upon expiration of the inactivity timer. For example, the UE 115-a may be configured to use the same or different sub-BWP channel configuration 230 for uplink and downlink communications, respectively, following expiration of the inactivity timer. For instance, in some examples, the UE 115-a may be configured to perform communications in accordance with a master sub-BWP channel configuration 230 (for example, the fourth sub-BWP channel configuration 230-d) or a BWP channel configuration spanning the entire BWP 225 upon expiration of the inactivity timer. In other words, the UE 115-a may be configured to fall back to half-duplex communications using a master sub-BWP channel configuration 230 or BWP channel configuration spanning the entirety of the active BWP 225 after expiration of the inactivity timer.

In additional or alternative aspects, the UE 115-a may be configured to switch between BWP channel configurations, sub-BWP channel configurations 230, or both, based on a BWP inactivity timer. The UE 115-a may be configured with a BWP inactivity timer via control signaling (for example, the RRC message 240). Additionally or alternatively, the UE 115-a may be pre-configured with a BWP inactivity timer. As compared to the inactivity timer describe previously herein which is associated with full-duplex communications (“full-duplex inactivity timer”) and triggers a transition from the full-duplex communication mode to the half-duplex communication mode, a BWP inactivity timer may trigger a transition between active BWP channel configurations or active sub-BWP channel configurations 230 to default BWP channel configurations or active sub-BWP channel configurations, respectively.

For example, the UE 115-a may be configured to initiate a BWP inactivity timer (for example, BWP-InactivityTimer) upon switching from a default BWP channel configuration (or default sub-BWP channel configuration) to a different active BWP channel configuration (or to a different active sub-BWP channel configuration). In this example, the UE 115-a may be configured to restart the BWP inactivity timer upon successfully decoding a control message (for example, a DCI message) which schedules a transmission within the active BWP channel configuration (or active sub-BWP channel configuration 230). Subsequently, if the UE 115-a does not perform, or is not scheduled, to perform communications in accordance with the active BWP channel configuration or active sub-BWP channel configuration 230, the UE 115-a may determine an expiration of the BWP channel configuration, and may switch from the active BWP channel configuration or active sub-BWP channel configuration 230 to the default BWP channel configuration or default sub-BWP channel configuration 230, respectively. In some examples, the UE 115-a may be configured to utilize an initial (starting) BWP channel configuration or initial sub-BWP channel configuration 230 as a default BWP channel configuration or default sub-BWP channel configuration 230 in cases in which the UE 115-a is not explicitly configured with a default BWP channel configuration or sub-BWP channel configuration 230.

Techniques of the present disclosure may enable improved wireless communications in the context of full-duplex and half-duplex communications. In particular, by configuring sub-BWP channel configurations 230 at the UE 115-a, techniques described herein may enable the UE 115-a to switch between a full-duplex communication mode and a half-duplex communication mode without performing BWP switching. Moreover, sub-BWP channel configurations 230 may provide improved granularity of uplink/downlink communication resources as compared to BWP channel configurations. Accordingly, by configuring UEs 115-a with sub-BWP channel configurations 230, techniques of the present disclosure may improve resource utilization in the context of both full-duplex communications and half-duplex communications.

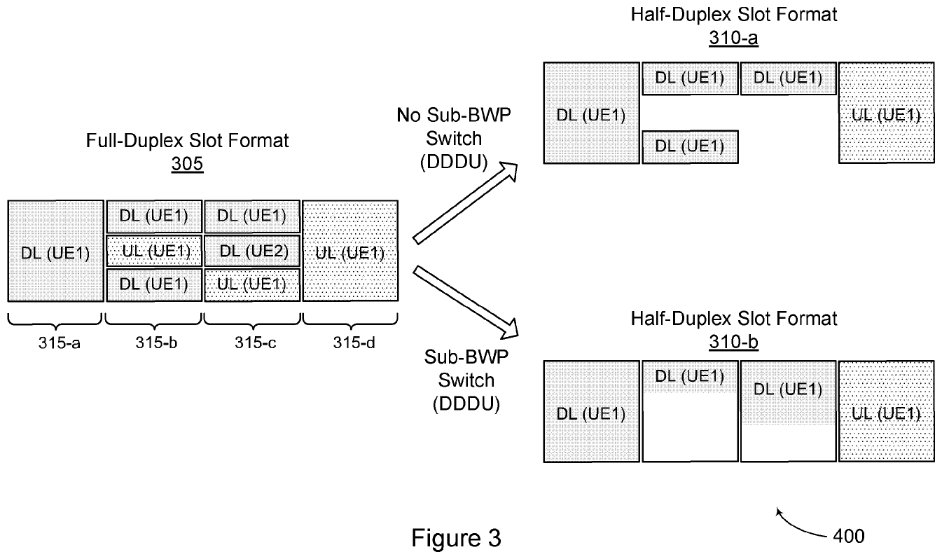

FIG. 3 illustrates an example of a resource configuration 300 that supports techniques for sub-BWP configurations usable for half-duplex communications and full-duplex communications in accordance with aspects of the present disclosure. The resource configuration 300 illustrates the transition from a full-duplex communication mode to a half-duplex communication mode at a UE 115 with and without switching sub-BWP channel configurations, as described previously herein.

As shown in FIG. 3, a UE 115 may be configured to communicate in accordance with a slot format 305 while operating in a full-duplex communication mode. The slot format 305 may illustrate the slot format from the perspective of a base station 105. The slot format 305 may define directions of communications resources across a first slot 315-a, a second slot 315-b, a third slot 315-c, and a fourth slot 315-d for a first UE 115 (UE1) and a second UE 115 (UE2). In particular, the slot format 305 may indicate one or more resource formats (uplink format, downlink format, full-duplex format) associated with each slot 315, as well as a frequency resource allocation for each slot 315. For example, the first slot 315-a may be associated with a downlink format, and the fourth slot 315-d may be associated with an uplink format. Moreover, the second slot 315-b and the third slot 315-c may be associated with a full-duplex format. In other words, the second slot 315-b and the third slot 315-c may include resources for both downlink and uplink communications (“D+U” slots 315). The full-duplex slot format 305 may illustrate a configuration for SBFD communications at the UE 115.

In some aspects, as described previously herein, a UE 115 (for example, UE1) may be configured to switch from a full-duplex communication mode to a half-duplex communication mode based on explicit signaling from a base station 105, based on an expiration of a full-duplex inactivity timer, or both. Moreover, in some examples, the first UE 115 (UE1) may be configured with non-mode-specific BWP channel configurations and non-mode-specific sub-BWP channel configurations (for example, sub-BWP channel configurations 230 illustrated in FIG. 2). With non-mode-specific BWP channel configurations and non-mode-specific sub-BWP channel configurations, the first UE 115 (UE1) may be able to switch duplexing modes without switching BWP channel configurations or sub-BWP channel configurations.

For example, upon an expiration of an inactivity timer associated with full-duplex communications at the first UE 115 (UE1) (or based on signaling from the base station 105), the first UE 115 may switch from the full-duplex communication mode to the half-duplex communication mode without switching any sub-BWP channel configurations. For instance, the UE 115 may switch from the full-duplex slot format 305 to the half-duplex slot format 310-a without any sub-BWP channel configuration switching. In this regard, the first UE 115 (UE1) may not switch any sub-BWP channel configurations if switching from SBFD to TDD, as illustrated in the transition from the full-duplex slot format 305 to the half-duplex slot format 310-a (same active sub-BWP channel configurations).

The box outlines of the resources illustrated in each slot 315 of the half-duplex slot format 310-a illustrate the active sub-BWP channel configurations for the first UE 115 (UE1) in the respective slots. Without switching any sub-BWP channel configurations from the full-duplex slot format 305 to the half-duplex slot format 310-a at the first UE 115 (UE1), the base station 105 and the first UE 115 may be unable to communicate within the resources of the third slot 315-c of full-duplex slot format 305 which were allocated for the second UE 115 (UE2). In other words, without switching any sub-BWP channel configurations from the full-duplex slot format 305 to the half-duplex slot format 310-a at the first UE 115 (UE1), the active sub-BWP channel configuration of the first UE 115 (UE1) within the third slot 315-c may not include the resources of the third slot 315-c of full-duplex slot format 305 which were allocated for the second UE 115 (UE2).

Comparatively, in some implementations, the first UE 115 may perform sub-BWP channel configuration switching if transitioning from the full-duplex communication mode to the half-duplex communication mode. For example, upon an expiration of an inactivity timer associated with full-duplex communications at the first UE 115 (or based on signaling from the base station 105), the first UE 115 (UE1) may switch from the full-duplex slot format 305 to the half-duplex slot format 310-b by performing sub-BWP channel configuration switching. In this regard, the one or more active uplink/downlink sub-BWP channel configurations may be switched if the first UE 115 transitions from SBFD to TDD, as illustrated in the transition from the full-duplex slot format 305 to the half-duplex slot format 310-b.

The box outlines of the resources illustrated in each slot 315 of the half-duplex slot format 310-b illustrate the active sub-BWP channel configurations for the first UE 115 (UE1) in the respective slots. In this example, by switching any sub-BWP channel configurations from the full-duplex slot format 305 to the half-duplex slot format 310-b at the first UE 115 (UE1), the base station 105 and the first UE 115 may be able to communicate within the resources of the third slot 315-c of full-duplex slot format 305 which were allocated for the second UE 115 (UE2). In other words, by switching sub-BWP channel configurations from the full-duplex slot format 305 to the half-duplex slot format 310-a at the first UE 115 (UE1), the active sub-BWP channel configuration of the first UE 115 (UE1) within the third slot 315-c may include the resources of the third slot 315-c of full-duplex slot format 305 which were allocated for the second UE 115 (UE2). Thus, in cases where the base station 105 and the first UE 115 (UE1) are to communicate within the resources of the full-duplex slot format 305 which were allocated to the second UE 115 (UE2), the first UE 115 (UE1) may be configured to switch sub-BWP channel configurations.

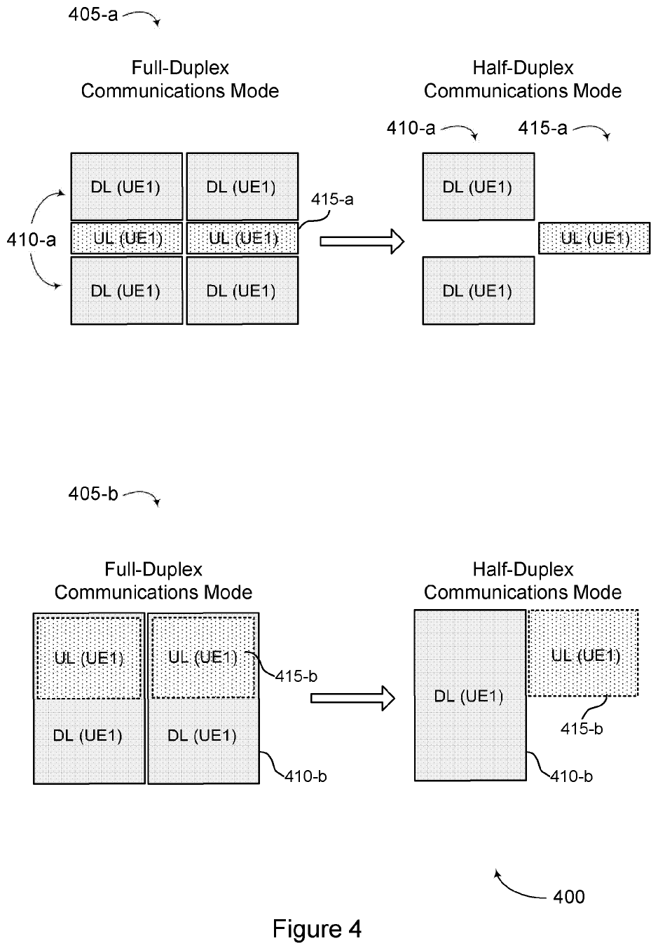

FIG. 4 illustrates an example of a resource configuration 400 that supports techniques for sub-BWP configurations usable for half-duplex communications and full-duplex communications in accordance with aspects of the present disclosure. In some aspects, the resource configuration 400 illustrates a first duplex mode switching configuration 405-a and a second duplex mode switching configuration 405-b for switching from a full-duplex communication mode to a half-duplex communication mode, as described with reference to FIGS. 1-3.

In some aspects, the first duplex mode switching configuration 405-a illustrates a set of resources configured for wireless communications at a UE 115 in a full-duplex communication mode. In particular, the first duplex mode switching configuration 405-a illustrates a first sub-BWP channel configuration 410-a associated with downlink communications at a UE 115, and a second sub-BWP channel configuration 415-a associated with uplink communications at the UE 115. While operating in the full-duplex communication mode, the first sub-BWP channel configuration 410-a and the second sub-BWP channel configuration 415-a may include sets of resources for downlink and uplink communications within the same TTI (same slot). For example, the first sub-BWP channel configuration 410-a and the second sub-BWP channel configuration 415-a may include sets of resources allocated for downlink and uplink communications, respectively, which are separated in the frequency domain. As such, the first duplex mode switching configuration 405-a may illustrate sub-BWP channel configurations 410-a, 415-b which are configured for SBFD communications at the UE 115.

Continuing with reference to the first duplex mode switching configuration 405-a, the UE 115 may switch from the full-duplex communication mode to the half-duplex communication mode without switching either the first sub-BWP channel configuration 410-a and the second sub-BWP channel configuration 415-a. The UE 115 may switch from the full-duplex communication mode to the half-duplex communication mode based on an expiration of an inactivity timer associated with full-duplex communications at the UE 115, or based on signaling from the base station 105, or both. In this regard, the first duplex mode switching configuration 405-a may illustrate a transition from SBFD communications to TDD communications (or sub-band half-duplex (SBHD) communications).

The second duplex mode switching configuration 405-b also illustrates a set of resources configured for wireless communications at a UE 115 in a full-duplex communication mode. In particular, the second duplex mode switching configuration 405-b illustrates a first sub-BWP channel configuration 410-b associated with downlink communications at a UE 115, and a second sub-BWP channel configuration 415-b associated with uplink communications at the UE 115. In some aspects, the first sub-BWP channel configuration 410-b for downlink communications may include master sub-BWP channel configuration which spans the entire active BWP in the frequency domain.

While operating in the full-duplex communication mode, the first sub-BWP channel configuration 410-b and the second sub-BWP channel configuration 415-b may include sets of resources for downlink and uplink communications within the same TTI (same slot). For example, the first sub-BWP channel configuration 410-a and the second sub-BWP channel configuration 415-a may include sets of resources allocated for downlink and uplink communications, respectively, which overlap in the frequency domain. As such, the first duplex mode switching configuration 405-a may illustrate sub-BWP channel configurations 410-a, 415-b which are configured for IBFD communications at the UE 115.

Continuing with reference to the second duplex mode switching configuration 405-b, the UE 115 may switch from the full-duplex communication mode to the half-duplex communication mode without switching either the first sub-BWP channel configuration 410-b and the second sub-BWP channel configuration 415-b. The UE 115 may switch from the full-duplex communication mode to the half-duplex communication mode based on an expiration of an inactivity timer associated with full-duplex communications at the UE 115, or based on signaling from the base station 105, or both. In this regard, the second duplex mode switching configuration 405-a may illustrate a transition from IBFD communications to TDD communications or SBHD communications.

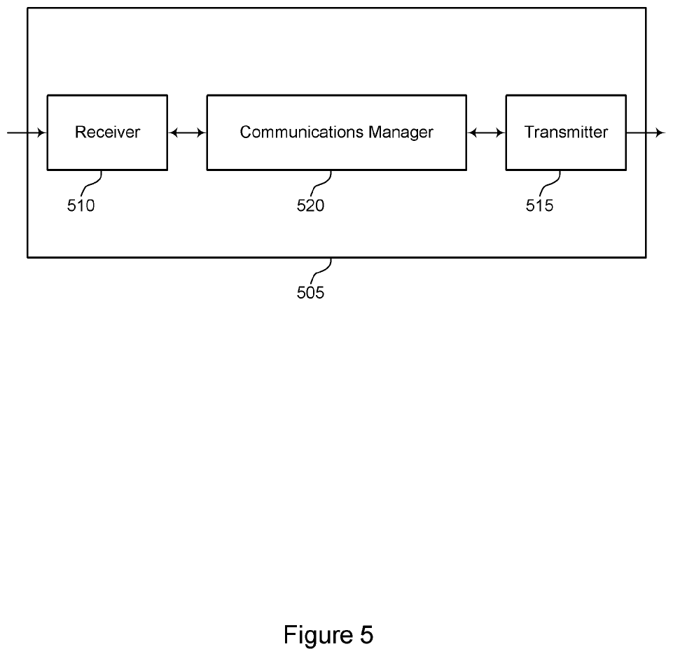

FIG. 5 shows a block diagram of a device 505 that supports techniques for sub-BWP configurations usable for half-duplex communications and full-duplex communications in accordance with aspects of the present disclosure. The device 505 may be an example of aspects of a UE 115 as described herein. The device 505 may include a receiver 510, a transmitter 515, and a communications manager 520. The device 505 may be implemented, at least in part, by one or both of a modem and a processor. Each of these components may be in communication with one another (for example, via one or more buses).

The receiver 510 may provide a means for receiving information such as packets, user data, control information, or any combination thereof associated with various information channels (for example, control channels, data channels, information channels related to techniques for sub-BWP configurations usable for half-duplex communications and full-duplex communications and changing duplex modes). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (for example, control channels, data channels, information channels related to techniques for sub-BWP configurations usable for half-duplex communications and full-duplex communications and changing duplex modes). In some examples, the transmitter 515 may be co-located with a receiver 510 in a transceiver component. The transmitter 515 may utilize a single antenna or a set of multiple antennas.

The communications manager 520, the receiver 510, the transmitter 515, or various combinations thereof or various components thereof may be examples of means for performing various aspects of techniques for sub-BWP configurations usable for half-duplex communications and full-duplex communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (for example, in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally or alternatively, in some examples, the communications manager 520, the receiver 510, the transmitter 515, or various combinations or components thereof may be implemented in code (for example, as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (for example, configured as or otherwise supporting a means for performing the functions described in the present disclosure).

In some examples, the communications manager 520 may be configured to perform various operations (for example, receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communication at a UE in accordance with examples as disclosed herein. For example, the communications manager 520 may be configured as or otherwise support a means for receiving, from a base station, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain. The communications manager 520 may be configured as or otherwise support a means for receiving, from the base station, a control message indicating a first sub-BWP channel configuration of the set of multiple sub-BWP channel configurations. The communications manager 520 may be configured as or otherwise support a means for communicating with the base station during a first TTI in accordance with the first sub-BWP channel configuration and in accordance with a communication mode that includes a full-duplex communication mode or a half-duplex communication mode.

By including or configuring the communications manager 520 in accordance with examples as described herein, the device 505 (for example, a processor controlling or otherwise coupled to the receiver 510, the transmitter 515, the communications manager 520, or a combination thereof) may support techniques for improved wireless communications in the context of full-duplex and half-duplex communications. In particular, by configuring sub-BWP channel configurations at a UE 115, techniques described herein may enable the UE 115 to switch between a full-duplex communication mode and a half-duplex communication mode without performing BWP switching. Moreover, sub-BWP channel configurations may provide improved granularity of uplink/downlink communication resources as compared to BWP channel configurations. Accordingly, by configuring UEs 115 with sub-BWP channel configurations, techniques of the present disclosure may improve resource utilization in the context of both full-duplex communications and half-duplex communications.

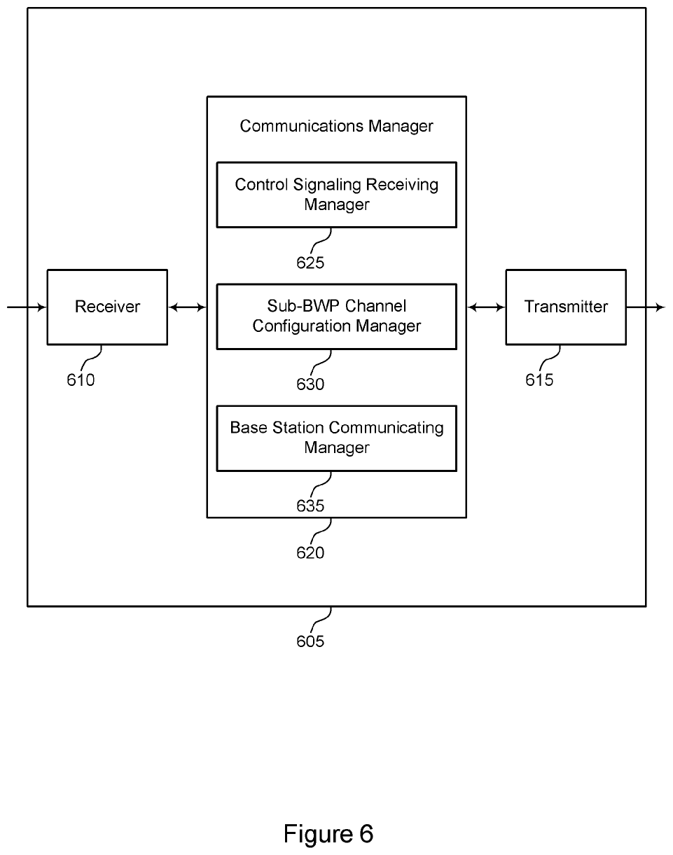

FIG. 6 shows a block diagram of a device 605 that supports techniques for sub-BWP configurations usable for half-duplex communications and full-duplex communications in accordance with aspects of the present disclosure. The device 605 may be an example of aspects of a device 505 or a UE 115 as described herein. The device 605 may include a receiver 610, a transmitter 615, and a communications manager 620. The device 605 may be implemented, at least in part, by one or both of a modem and a processor. Each of these components may be in communication with one another (for example, via one or more buses).

The receiver 610 may provide a means for receiving information such as packets, user data, control information, or any combination thereof associated with various information channels (for example, control channels, data channels, information channels related to techniques for sub-BWP configurations usable for half-duplex communications and full-duplex communications and changing duplex modes). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (for example, control channels, data channels, information channels related to techniques for sub-BWP configurations usable for half-duplex communications and full-duplex communications and changing duplex modes). In some examples, the transmitter 615 may be co-located with a receiver 610 in a transceiver component. The transmitter 615 may utilize a single antenna or a set of multiple antennas.

The device 605, or various components thereof, may be an example of means for performing various aspects of techniques for sub-BWP configurations usable for half-duplex communications and full-duplex communications as described herein. For example, the communications manager 620 may include a control signaling receiving manager 625, a sub-BWP channel configuration manager 630, a base station communicating manager 635, or any combination thereof. In some examples, the communications manager 620, or various components thereof, may be configured to perform various operations (for example, receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. The control signaling receiving manager 625 may be configured as or otherwise support a means for receiving, from a base station, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain. The sub-BWP channel configuration manager 630 may be configured as or otherwise support a means for receiving, from the base station, a control message indicating a first sub-BWP channel configuration of the set of multiple sub-BWP channel configurations. The base station communicating manager 635 may be configured as or otherwise support a means for communicating with the base station during a first TTI in accordance with the first sub-BWP channel configuration and in accordance with a communication mode that includes a full-duplex communication mode or a half-duplex communication mode.

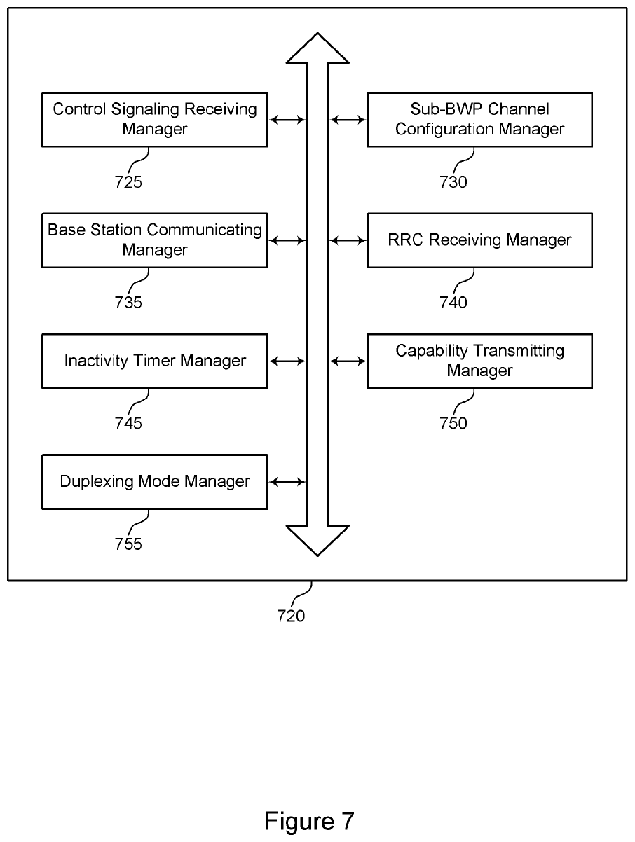

FIG. 7 shows a block diagram of a communications manager 720 that supports techniques for sub-BWP configurations usable for half-duplex communications and full-duplex communications in accordance with aspects of the present disclosure. The communications manager 720, or various components thereof, may be an example of means for performing various aspects of techniques for sub-BWP configurations usable for half-duplex communications and full-duplex communications as described herein. For example, the communications manager 720 may include a control signaling receiving manager 725, a sub-BWP channel configuration manager 730, a base station communicating manager 735, an RRC receiving manager 740, an inactivity timer manager 745, a capability transmitting manager 750, a duplexing mode manager 755, or any combination thereof. Each of these components may communicate, directly or indirectly, with one another (for example, via one or more buses).

The communications manager 720 may support wireless communication at a UE in accordance with examples as disclosed herein. The control signaling receiving manager 725 may be configured as or otherwise support a means for receiving, from a base station, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain. The sub-BWP channel configuration manager 730 may be configured as or otherwise support a means for receiving, from the base station, a control message indicating a first sub-BWP channel configuration of the set of multiple sub-BWP channel configurations. The base station communicating manager 735 may be configured as or otherwise support a means for communicating with the base station during a first TTI in accordance with the first sub-BWP channel configuration and in accordance with a communication mode that includes a full-duplex communication mode or a half-duplex communication mode.

In some examples, the control signaling receiving manager 725 may be configured as or otherwise support a means for receiving, from the base station via the control signaling, a set of multiple BWP channel configurations for wireless communications at the UE, where each BWP channel configuration of the set of multiple BWP channel configurations includes one or more sets of resources spanning the entire BWP in the frequency domain, where communicating with the base station during the first TTI is based on receiving the set of multiple BWP channel configurations.

In some examples, the duplexing mode manager 755 may be configured as or otherwise support a means for receiving, from the base station, an indication to perform communications in accordance with the half-duplex communication mode. In some examples, the base station communicating manager 735 may be configured as or otherwise support a means for communicating with the base station during a second TTI in accordance with a BWP channel configuration of the set of multiple BWP channel configurations and in accordance with the half-duplex communication mode based on receiving the indication to perform communications in accordance with the half-duplex communication mode.

In some examples, at least one sub-BWP channel configuration of the set of multiple sub-BWP channel configurations includes a set of resources spanning the entire BWP in the frequency domain. In some examples, the sub-BWP channel configuration manager 730 may be configured as or otherwise support a means for receiving, from the base station, a second control message indicating a second sub-BWP channel configuration of the set of multiple sub-BWP channel configurations. In some examples, the base station communicating manager 735 may be configured as or otherwise support a means for communicating with the base station during a second TTI in accordance with the second sub-BWP channel configuration and in accordance with the communication mode.

In some examples, the control signaling receiving manager 725 may be configured as or otherwise support a means for receiving, from the base station via the control signaling, an indication of a first subset of the set of multiple sub-BWP channel configurations that are associated with downlink communications at the UE and of a second subset of the set of multiple sub-BWP channel configurations which are associated with uplink communications at the UE, where communicating with the base station during the first TTI is based on receiving the indication of the first subset of the set of multiple sub-BWP channel configurations and the second subset of the set of multiple sub-BWP channel configurations.

In some examples, to support communicating with the base station during the first TTI, the base station communicating manager 735 may be configured as or otherwise support a means for receiving a first downlink transmission from the base station during the first TTI in accordance with the first sub-BWP channel configuration. In some examples, to support communicating with the base station during the first TTI, the base station communicating manager 735 may be configured as or otherwise support a means for transmitting a first uplink transmission to the base station during the first TTI in accordance with a second sub-BWP channel configuration associated with uplink communications at the UE.

In some examples, the sub-BWP channel configuration manager 730 may be configured as or otherwise support a means for receiving an indication to switch from the first sub-BWP channel configuration to a third sub-BWP channel configuration associated with downlink communications at the UE. In some examples, the base station communicating manager 735 may be configured as or otherwise support a means for receiving a second downlink transmission from the base station during a second TTI in accordance with the third sub-BWP channel configuration. In some examples, the base station communicating manager 735 may be configured as or otherwise support a means for transmitting a second uplink transmission to the base station during the first TTI in accordance with the second sub-BWP channel configuration.

In some examples, the sub-BWP channel configuration manager 730 may be configured as or otherwise support a means for where each sub-BWP channel configuration of the set of multiple sub-BWP channel configurations includes one of a dedicated sub-BWP channel configuration, a dormant sub-BWP channel configuration, a default sub-BWP channel configuration, or a first active sub-BWP channel configuration. In some examples, the sub-BWP channel configuration manager 730 may be configured as or otherwise support a means for where each sub-BWP channel configuration of the set of multiple sub-BWP channel configurations is associated with one of a dedicated BWP, a default BWP, or a first active BWP.

In some examples, the RRC receiving manager 740 may be configured as or otherwise support a means for receiving, from the base station, an RRC message indicating a first active BWP channel configuration associated with the full-duplex communication mode, where communicating with the base station during the first TTI includes communicating in accordance with the first active BWP channel configuration based on performing an RRC configuration procedure, performing an RRC reconfiguration procedure, or activating a secondary cell.

In some examples, the control signaling receiving manager 725 may be configured as or otherwise support a means for receiving, from the base station via the control signaling, an indication of a first active sub-BWP channel configuration of the set of multiple sub-BWP channel configurations that is associated with the first active BWP channel configuration, where communicating with the base station in accordance with the first active BWP channel configuration includes communicating with the base station in accordance with the first active sub-BWP channel configuration.

In some examples, the base station communicating manager 735 may be configured as or otherwise support a means for communicating with the base station in accordance with a first active BWP channel configuration associated with the half-duplex communication mode based on an absence of an additional first active BWP channel configuration that is associated with the full-duplex communication mode and based on performing an RRC configuration procedure, performing an RRC reconfiguration procedure, or activating a secondary cell.

In some examples, the inactivity timer manager 745 may be configured as or otherwise support a means for initiating an inactivity timer associated with the full-duplex communication mode. In some examples, the base station communicating manager 735 may be configured as or otherwise support a means for communicating with the base station during the first TTI in accordance with the first sub-BWP channel configuration and in accordance with the full-duplex communication mode based on initiating the inactivity timer.

In some examples, the RRC receiving manager 740 may be configured as or otherwise support a means for receiving, from the base station, an RRC message indicating information associated with the inactivity timer, where initiating the inactivity timer is based on receiving the RRC message.

In some examples, the base station communicating manager 735 may be configured as or otherwise support a means for communicating with the base station during an additional TTI before the first TTI in accordance with the half-duplex communication mode. In some examples, the duplexing mode manager 755 may be configured as or otherwise support a means for receiving, from the base station, an indication to transition from the half-duplex communication mode to the full-duplex communication mode, where initiating the inactivity timer is based on the indication to transition from the half-duplex communication mode to the full-duplex communication mode.

In some examples, the indication to transition from the half-duplex communication mode to the full-duplex communication mode is received via a DCI message, a downlink control channel transmission scheduling communications associated with the full-duplex communication mode, a configured grant, an additional control message associated with semi-persistent scheduling, or any combination thereof.

In some examples, the inactivity timer manager 745 may be configured as or otherwise support a means for restarting the inactivity timer based on communicating with the base station in accordance with the full-duplex communication mode. In some examples, the inactivity timer manager 745 may be configured as or otherwise support a means for determining an expiration of the inactivity timer based on a duration of the inactivity timer and based on an absence of communications performed in accordance with the full-duplex communication mode within the duration of the inactivity timer. In some examples, the duplexing mode manager 755 may be configured as or otherwise support a means for transitioning from the full-duplex communication mode to the half-duplex communication mode based on the expiration of the inactivity timer. In some examples, the base station communicating manager 735 may be configured as or otherwise support a means for communicating with the base station during a second TTI after the first TTI in accordance with the half-duplex communication mode and based on transitioning from the full-duplex communication mode to the half-duplex communication mode.

In some examples, the inactivity timer manager 745 may be configured as or otherwise support a means for determining an expiration of an inactivity timer associated with the full-duplex communication mode. In some examples, the base station communicating manager 735 may be configured as or otherwise support a means for communicating with the base station during a second TTI after the first TTI in accordance with the first sub-BWP channel configuration and in accordance with the half-duplex communication mode based on the expiration of the inactivity timer.

In some examples, the inactivity timer manager 745 may be configured as or otherwise support a means for determining an expiration of an inactivity timer associated with the full-duplex communication mode. In some examples, the base station communicating manager 735 may be configured as or otherwise support a means for communicating with the base station during a second TTI after the first TTI in accordance with a second sub-BWP channel configuration and the half-duplex communication mode based on the expiration of the inactivity timer.

In some examples, the RRC receiving manager 740 may be configured as or otherwise support a means for receiving, from the base station, an RRC message indicating the second sub-BWP channel configuration, where communicating during the second TTI in accordance with the second sub-BWP channel configuration is based on receiving the RRC message. In some examples, the second sub-BWP channel configuration includes a set of resources spanning the entire BWP in the frequency domain.

In some examples, the capability transmitting manager 750 may be configured as or otherwise support a means for transmitting, to the base station, a UE capability indication associated with the full-duplex communication mode at the UE, where receiving the control signaling, receiving the control message, communicating during the first TTI, or any combination thereof, is based on transmitting the UE capability indication. In some examples, the UE capability indication includes a first capability of the UE to perform communications according to the full-duplex communication mode, a second capability of the UE to switch between the half-duplex communication mode and the full-duplex communication mode, a third capability of the UE to perform full-duplex communications according to an inactivity timer, a fourth capability of the UE to perform full-duplex communications using a first active BWP channel configuration, a fifth capability of the UE to perform full-duplex communications using a first active sub-BWP channel configuration, or any combination thereof.

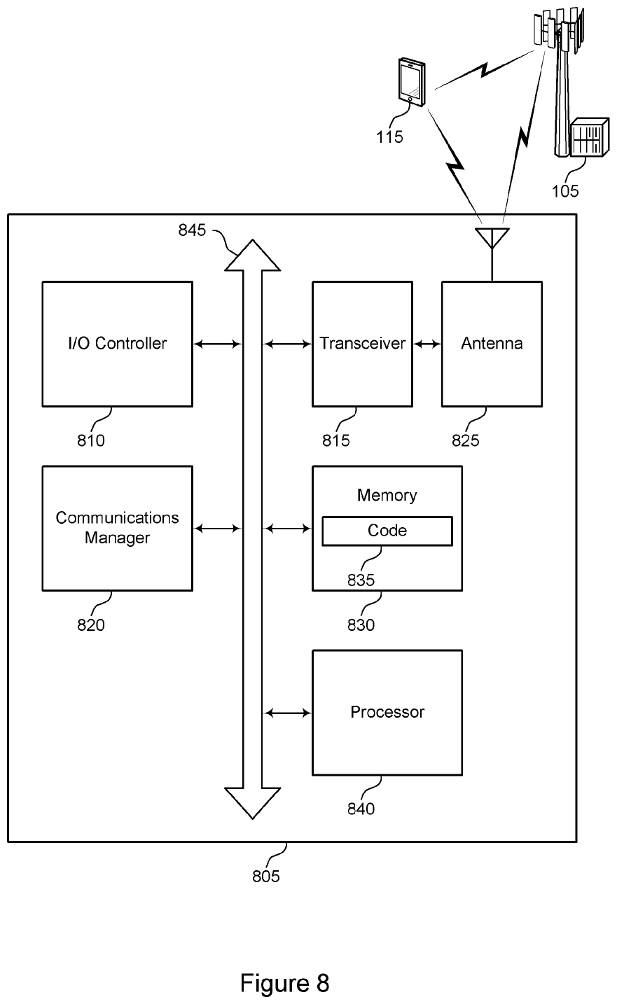

FIG. 8 shows a diagram of a system 800 including a device 805 that supports techniques for sub-BWP configurations usable for half-duplex communications and full-duplex communications in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (for example, operatively, communicatively, functionally, electronically, electrically) via one or more buses (for example, a bus 845).

The I/O controller 810 may manage input and output signals for the device 805. The I/O controller 810 may also manage peripherals not integrated into the device 805. In some examples, the I/O controller 810 may represent a physical connection or port to an external peripheral. In some examples, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some examples, the I/O controller 810 may be implemented as part of a processor, such as the processor 840. In some examples, a user may interact with the device 805 via the I/O controller 810 or via hardware components controlled by the I/O controller 810.

In some examples, the device 805 may include a single antenna 825. However, in some other examples, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some examples, the code 835 may not be directly executable by the processor 840 but may cause a computer (for example, when compiled and executed) to perform functions described herein. In some examples, the memory 830 may contain, among other things, a basic I/O system (BIOS) which may control basic hardware or software operation such as the interaction with peripheral components or devices.

The processor 840 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some examples, the processor 840 may be configured to operate a memory array using a memory controller. In some other examples, a memory controller may be integrated into the processor 840. The processor 840 may be configured to execute computer-readable instructions stored in a memory (for example, the memory 830) to cause the device 805 to perform various functions (for example, functions or tasks supporting techniques for sub-BWP configurations usable for half-duplex communications and full-duplex communications and changing duplex modes). For example, the device 805 or a component of the device 805 may include a processor 840 and memory 830 coupled to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving, from a base station, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain. The communications manager 820 may be configured as or otherwise support a means for receiving, from the base station, a control message indicating a first sub-BWP channel configuration of the set of multiple sub-BWP channel configurations. The communications manager 820 may be configured as or otherwise support a means for communicating with the base station during a first TTI in accordance with the first sub-BWP channel configuration and in accordance with a communication mode that includes a full-duplex communication mode or a half-duplex communication mode.

By including or configuring the communications manager 820 in accordance with examples as described herein, the device 805 may support techniques for improved wireless communications in the context of full-duplex and half-duplex communications. In particular, by configuring sub-BWP channel configurations at a UE 115, techniques described herein may enable the UE 115 to switch between a full-duplex communication mode and a half-duplex communication mode without performing BWP switching. Moreover, sub-BWP channel configurations may provide improved granularity of uplink/downlink communication resources as compared to BWP channel configurations. Accordingly, by configuring UEs 115 with sub-BWP channel configurations, techniques of the present disclosure may improve resource utilization in the context of both full-duplex communications and half-duplex communications.

In some examples, the communications manager 820 may be configured to perform various operations (for example, receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for sub-BWP configurations usable for half-duplex communications and full-duplex communications as described herein, or the processor 840 and the memory 830 may be otherwise configured to perform or support such operations.

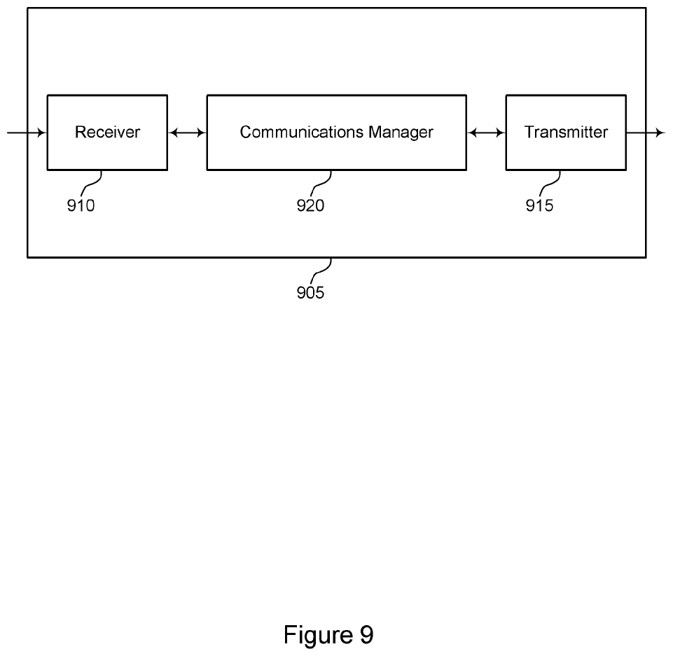

FIG. 9 shows a block diagram of a device 905 that supports techniques for sub-BWP configurations usable for half-duplex communications and full-duplex communications in accordance with aspects of the present disclosure. The device 905 may be an example of aspects of a base station 105 as described herein. The device 905 may include a receiver 910, a transmitter 915, and a communications manager 920. The device 905 may be implemented, at least in part, by one or both of a modem and a processor. Each of these components may be in communication with one another (for example, via one or more buses).

The receiver 910 may provide a means for receiving information such as packets, user data, control information, or any combination thereof associated with various information channels (for example, control channels, data channels, information channels related to techniques for sub-BWP configurations usable for half-duplex communications and full-duplex communications and changing duplex modes). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (for example, control channels, data channels, information channels related to techniques for sub-BWP configurations usable for half-duplex communications and full-duplex communications and changing duplex modes). In some examples, the transmitter 915 may be co-located with a receiver 910 in a transceiver component. The transmitter 915 may utilize a single antenna or a set of multiple antennas.

The communications manager 920, the receiver 910, the transmitter 915, or various combinations thereof or various components thereof may be examples of means for performing various aspects of techniques for sub-BWP configurations usable for half-duplex communications and full-duplex communications as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (for example, in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally or alternatively, in some examples, the communications manager 920, the receiver 910, the transmitter 915, or various combinations or components thereof may be implemented in code (for example, as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (for example, configured as or otherwise supporting a means for performing the functions described in the present disclosure).

In some examples, the communications manager 920 may be configured to perform various operations (for example, receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a base station in accordance with examples as disclosed herein. For example, the communications manager 920 may be configured as or otherwise support a means for transmitting, to a UE, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain. The communications manager 920 may be configured as or otherwise support a means for transmitting, to the UE, a control message indicating a first sub-BWP channel configuration of the set of multiple sub-BWP channel configurations. The communications manager 920 may be configured as or otherwise support a means for communicating with the UE during a first TTI in accordance with the first sub-BWP channel configuration and in accordance with a communication mode at the UE, where the communication mode includes a full-duplex communication mode or a half-duplex communication mode.

By including or configuring the communications manager 920 in accordance with examples as described herein, the device 905 (for example, a processor controlling or otherwise coupled to the receiver 910, the transmitter 915, the communications manager 920, or a combination thereof) may support techniques for improved wireless communications in the context of full-duplex and half-duplex communications. In particular, by configuring sub-BWP channel configurations at a UE 115, techniques described herein may enable the UE 115 to switch between a full-duplex communication mode and a half-duplex communication mode without performing BWP switching. Moreover, sub-BWP channel configurations may provide improved granularity of uplink/downlink communication resources as compared to BWP channel configurations. Accordingly, by configuring UEs 115 with sub-BWP channel configurations, techniques of the present disclosure may improve resource utilization in the context of both full-duplex communications and half-duplex communications.

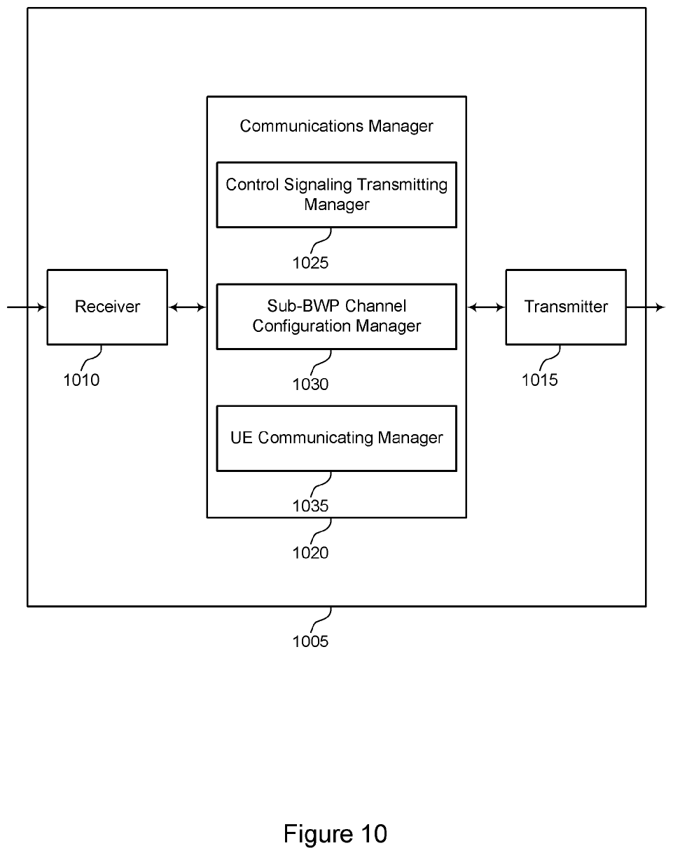

FIG. 10 shows a block diagram of a device 1005 that supports techniques for sub-BWP configurations usable for half-duplex communications and full-duplex communications in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may be implemented, at least in part, by one or both of a modem and a processor. Each of these components may be in communication with one another (for example, via one or more buses).

The receiver 1010 may provide a means for receiving information such as packets, user data, control information, or any combination thereof associated with various information channels (for example, control channels, data channels, information channels related to techniques for sub-BWP configurations usable for half-duplex communications and full-duplex communications and changing duplex modes). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (for example, control channels, data channels, information channels related to techniques for sub-BWP configurations usable for half-duplex communications and full-duplex communications and changing duplex modes). In some examples, the transmitter 1015 may be co-located with a receiver 1010 in a transceiver component. The transmitter 1015 may utilize a single antenna or a set of multiple antennas.

The device 1005, or various components thereof, may be an example of means for performing various aspects of techniques for sub-BWP configurations usable for half-duplex communications and full-duplex communications as described herein. For example, the communications manager 1020 may include a control signaling transmitting manager 1025, a sub-BWP channel configuration manager 1030, a UE communicating manager 1035, or any combination thereof. In some examples, the communications manager 1020, or various components thereof, may be configured to perform various operations (for example, receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a base station in accordance with examples as disclosed herein. The control signaling transmitting manager 1025 may be configured as or otherwise support a means for transmitting, to a UE, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain. The sub-BWP channel configuration manager 1030 may be configured as or otherwise support a means for transmitting, to the UE, a control message indicating a first sub-BWP channel configuration of the set of multiple sub-BWP channel configurations. The UE communicating manager 1035 may be configured as or otherwise support a means for communicating with the UE during a first TTI in accordance with the first sub-BWP channel configuration and in accordance with a communication mode at the UE, where the communication mode includes a full-duplex communication mode or a half-duplex communication mode.

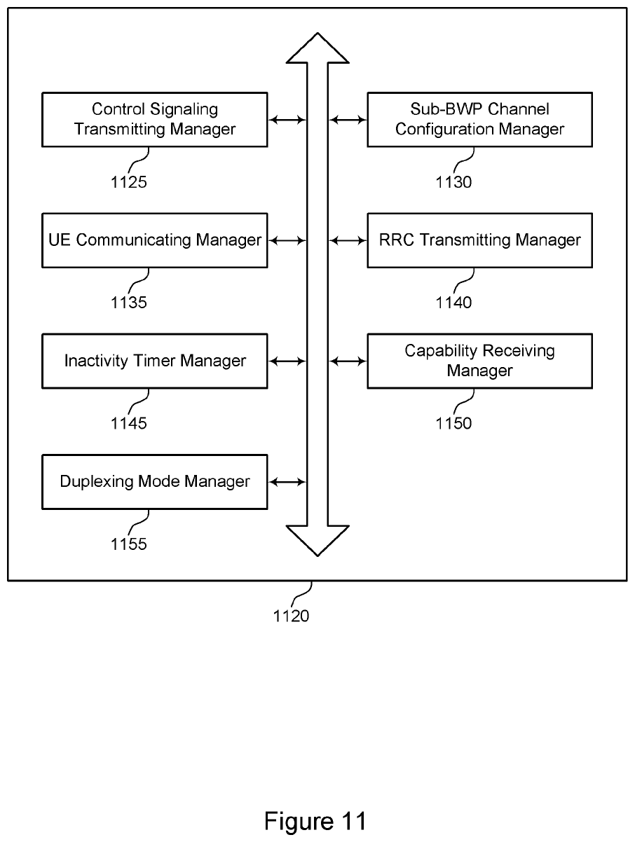

FIG. 11 shows a block diagram of a communications manager 1120 that supports techniques for sub-BWP configurations usable for half-duplex communications and full-duplex communications in accordance with aspects of the present disclosure. The communications manager 1120, or various components thereof, may be an example of means for performing various aspects of techniques for sub-BWP configurations usable for half-duplex communications and full-duplex communications as described herein. For example, the communications manager 1120 may include a control signaling transmitting manager 1125, a sub-BWP channel configuration manager 1130, a UE communicating manager 1135, an RRC transmitting manager 1140, an inactivity timer manager 1145, a capability receiving manager 1150, a duplexing mode manager 1155, or any combination thereof. Each of these components may communicate, directly or indirectly, with one another (for example, via one or more buses).

The communications manager 1120 may support wireless communication at a base station in accordance with examples as disclosed herein. The control signaling transmitting manager 1125 may be configured as or otherwise support a means for transmitting, to a UE, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain. The sub-BWP channel configuration manager 1130 may be configured as or otherwise support a means for transmitting, to the UE, a control message indicating a first sub-BWP channel configuration of the set of multiple sub-BWP channel configurations. The UE communicating manager 1135 may be configured as or otherwise support a means for communicating with the UE during a first TTI in accordance with the first sub-BWP channel configuration and in accordance with a communication mode at the UE, where the communication mode includes a full-duplex communication mode or a half-duplex communication mode.

In some examples, the control signaling transmitting manager 1125 may be configured as or otherwise support a means for transmitting, to the UE via the control signaling, a set of multiple BWP channel configurations for wireless communications at the UE, where each BWP channel configuration of the set of multiple BWP channel configurations includes one or more sets of resources spanning the entire BWP in the frequency domain, where communicating with the UE during the first TTI is based on transmitting the set of multiple BWP channel configurations.

In some examples, the duplexing mode manager 1155 may be configured as or otherwise support a means for transmitting, to the UE, an indication to perform communications in accordance with the half-duplex communication mode. In some examples, the UE communicating manager 1135 may be configured as or otherwise support a means for communicating with the UE during a second TTI in accordance with a BWP channel configuration of the set of multiple BWP channel configurations and in accordance with the half-duplex communication mode based on transmitting the indication to perform communications in accordance with the half-duplex communication mode.

In some examples, at least one sub-BWP channel configuration of the set of multiple sub-BWP channel configurations includes a set of resources spanning the entire BWP in the frequency domain. In some examples, the sub-BWP channel configuration manager 1130 may be configured as or otherwise support a means for transmitting, to the UE, a second control message indicating a second sub-BWP channel configuration of the set of multiple sub-BWP channel configurations. In some examples, the UE communicating manager 1135 may be configured as or otherwise support a means for communicating with the UE during a second TTI in accordance with the second sub-BWP channel configuration and in accordance with the communication mode.

In some examples, the control signaling transmitting manager 1125 may be configured as or otherwise support a means for transmitting, to the UE via the control signaling, an indication of a first subset of the set of multiple sub-BWP channel configurations that are associated with downlink communications at the UE and of a second subset of the set of multiple sub-BWP channel configurations which are associated with uplink communications at the UE, where communicating with the UE during the first TTI is based on transmitting the indication of the first subset of the set of multiple sub-BWP channel configurations and the second subset of the set of multiple sub-BWP channel configurations.

In some examples, to support communicating with the UE during the first TTI, the UE communicating manager 1135 may be configured as or otherwise support a means for transmitting a first downlink transmission to the UE during the first TTI in accordance with the first sub-BWP channel configuration. In some examples, to support communicating with the UE during the first TTI, the UE communicating manager 1135 may be configured as or otherwise support a means for receiving a first uplink transmission from the UE during the first TTI in accordance with a second sub-BWP channel configuration associated with uplink communications at the UE.

In some examples, the sub-BWP channel configuration manager 1130 may be configured as or otherwise support a means for transmitting an indication to switch from the first sub-BWP channel configuration to a third sub-BWP channel configuration associated with downlink communications at the UE. In some examples, the UE communicating manager 1135 may be configured as or otherwise support a means for transmitting a second downlink transmission to the UE during a second TTI in accordance with the third sub-BWP channel configuration. In some examples, the UE communicating manager 1135 may be configured as or otherwise support a means for receiving a second uplink transmission from the UE during the first TTI in accordance with the second sub-BWP channel configuration.

In some examples, the sub-BWP channel configuration manager 1130 may be configured as or otherwise support a means for where each sub-BWP channel configuration of the set of multiple sub-BWP channel configurations includes one of a dedicated sub-BWP channel configuration, a dormant sub-BWP channel configuration, a default sub-BWP channel configuration, or a first active sub-BWP channel configuration. In some examples, the sub-BWP channel configuration manager 1130 may be configured as or otherwise support a means for where each sub-BWP channel configuration of the set of multiple sub-BWP channel configurations is associated with one of a dedicated BWP, a default BWP, or a first active BWP.

In some examples, the RRC transmitting manager 1140 may be configured as or otherwise support a means for transmitting, to the UE, an RRC message indicating a first active BWP channel configuration associated with the full-duplex communication mode, where communicating with the UE during the first TTI includes communicating in accordance with the first active BWP channel configuration.

In some examples, the sub-BWP channel configuration manager 1130 may be configured as or otherwise support a means for transmitting, to the UE via the control signaling, an indication of a first active sub-BWP channel configuration of the set of multiple sub-BWP channel configurations that is associated with the first active BWP channel configuration, where communicating with the UE in accordance with the first active BWP channel configuration includes communicating with the UE in accordance with the first active sub-BWP channel configuration.

In some examples, the UE communicating manager 1135 may be configured as or otherwise support a means for communicating with the UE in accordance with a first active BWP channel configuration associated with the half-duplex communication mode based on an absence of an additional first active BWP channel configuration that is associated with the full-duplex communication mode.

In some examples, the inactivity timer manager 1145 may be configured as or otherwise support a means for initiating an inactivity timer associated with the full-duplex communication mode at the UE. In some examples, the UE communicating manager 1135 may be configured as or otherwise support a means for communicating with the UE during the first TTI in accordance with the first sub-BWP channel configuration and in accordance with the full-duplex communication mode based on initiating the inactivity timer.

In some examples, the RRC transmitting manager 1140 may be configured as or otherwise support a means for transmitting, to the UE, an RRC message indicating information associated with the inactivity timer, where initiating the inactivity timer is based on transmitting the RRC message.

In some examples, the UE communicating manager 1135 may be configured as or otherwise support a means for communicating with the UE during an additional TTI before the first TTI in accordance with the half-duplex communication mode. In some examples, the duplexing mode manager 1155 may be configured as or otherwise support a means for transmitting, to the UE, an indication to transition from the half-duplex communication mode to the full-duplex communication mode, where initiating the inactivity timer is based on the indication to transition from the half-duplex communication mode to the full-duplex communication mode.

In some examples, the indication to transition from the half-duplex communication mode to the full-duplex communication mode is transmitted via a DCI message, a downlink control channel transmission scheduling communications associated with the full-duplex communication mode, a configured grant, an additional control message associated with semi-persistent scheduling, or any combination thereof.

In some examples, the inactivity timer manager 1145 may be configured as or otherwise support a means for restarting the inactivity timer based on communicating with the UE in accordance with the full-duplex communication mode. In some examples, the inactivity timer manager 1145 may be configured as or otherwise support a means for determining an expiration of the inactivity timer based on a duration of the inactivity timer and based on an absence of communications performed at the UE in accordance with the full-duplex communication mode within the duration of the inactivity timer. In some examples, the UE communicating manager 1135 may be configured as or otherwise support a means for communicating with the UE during a second TTI after the first TTI in accordance with the half-duplex communication mode and based on the UE transitioning from the full-duplex communication mode to the half-duplex communication mode.

In some examples, the inactivity timer manager 1145 may be configured as or otherwise support a means for determining an expiration of an inactivity timer associated with the full-duplex communication mode. In some examples, the UE communicating manager 1135 may be configured as or otherwise support a means for communicating with the UE during a second TTI after the first TTI in accordance with the first sub-BWP channel configuration and in accordance with the half-duplex communication mode based on the expiration of the inactivity timer.

In some examples, the inactivity timer manager 1145 may be configured as or otherwise support a means for determining an expiration of an inactivity timer associated with the full-duplex communication mode at the UE. In some examples, the UE communicating manager 1135 may be configured as or otherwise support a means for communicating with the UE during a second TTI after the first TTI in accordance with a second sub-BWP channel configuration and the half-duplex communication mode based on the expiration of the inactivity timer.

In some examples, the RRC transmitting manager 1140 may be configured as or otherwise support a means for transmitting, to the UE, an RRC message indicating the second sub-BWP channel configuration, where communicating during the second TTI in accordance with the second sub-BWP channel configuration is based on transmitting the RRC message. In some examples, the second sub-BWP channel configuration includes a set of resources spanning the entire BWP in the frequency domain.

In some examples, the capability receiving manager 1150 may be configured as or otherwise support a means for receiving, from the UE, a UE capability indication associated with the full-duplex communication mode at the UE, where transmitting the control signaling, transmitting the control message, communicating during the first TTI, or any combination thereof, is based on receiving the UE capability indication. In some examples, the UE capability indication includes a first capability of the UE to perform communications according to the full-duplex communication mode, a second capability of the UE to switch between the half-duplex communication mode and the full-duplex communication mode, a third capability of the UE to perform full-duplex communications according to an inactivity timer, a fourth capability of the UE to perform full-duplex communications using a first active BWP channel configuration, a fifth capability of the UE to perform full-duplex communications using a first active sub-BWP channel configuration, or any combination thereof.

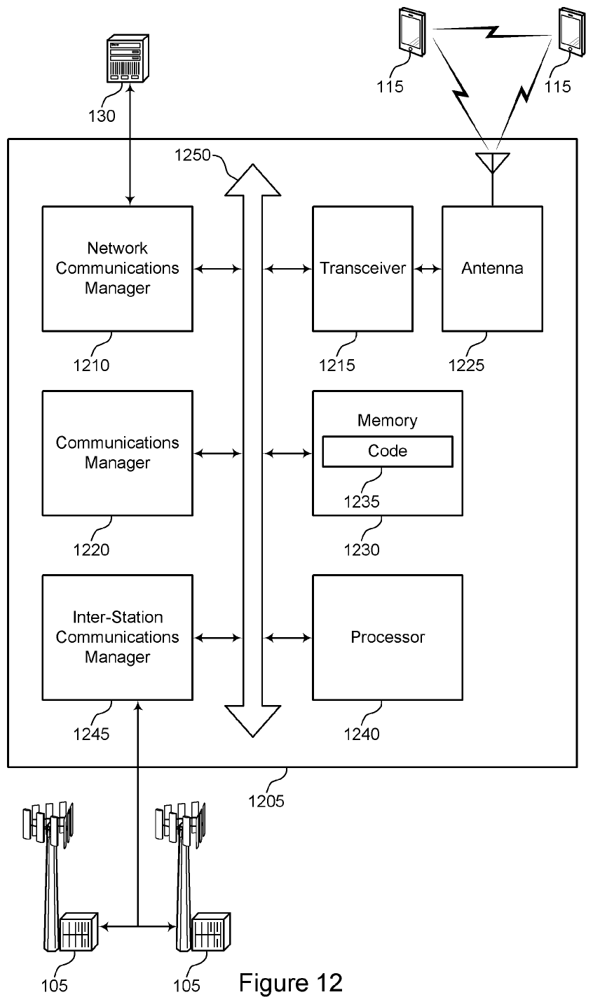

FIG. 12 shows a diagram of a system 1200 including a device 1205 that supports techniques for sub-BWP configurations usable for half-duplex communications and full-duplex communications in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (for example, operatively, communicatively, functionally, electronically, electrically) via one or more buses (for example, a bus 1250).

The network communications manager 1210 may manage communications with a core network 130 (for example, via one or more wired backhaul links). For example, the network communications manager 1210 may manage the transfer of data communications for client devices, such as one or more UEs 115.

In some examples, the device 1205 may include a single antenna 1225. However, in some other examples the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some examples, the code 1235 may not be directly executable by the processor 1240 but may cause a computer (for example, when compiled and executed) to perform functions described herein. In some examples, the memory 1230 may contain, among other things, a BIOS which may control basic hardware or software operation such as the interaction with peripheral components or devices.

The processor 1240 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some examples, the processor 1240 may be configured to operate a memory array using a memory controller. In some other examples, a memory controller may be integrated into the processor 1240. The processor 1240 may be configured to execute computer-readable instructions stored in a memory (for example, the memory 1230) to cause the device 1205 to perform various functions (for example, functions or tasks supporting techniques for sub-BWP configurations usable for half-duplex communications and full-duplex communications and changing duplex modes). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a base station in accordance with examples as disclosed herein. For example, the communications manager 1220 may be configured as or otherwise support a means for transmitting, to a UE, control signaling indicating a set of multiple sub-BWP channel configurations for wireless communications at the UE, where each sub-BWP channel configuration of the set of multiple sub-BWP channel configurations includes one or more sets of resources spanning at least a portion of a BWP in the frequency domain. The communications manager 1220 may be configured as or otherwise support a means for transmitting, to the UE, a control message indicating a first sub-BWP channel configuration of the set of multiple sub-BWP channel configurations. The communications manager 1220 may be configured as or otherwise support a means for communicating with the UE during a first TTI in accordance with the first sub-BWP channel configuration and in accordance with a communication mode at the UE, where the communication mode includes a full-duplex communication mode or a half-duplex communication mode.

By including or configuring the communications manager 1220 in accordance with examples as described herein, the device 1205 may support techniques for improved wireless communications in the context of full-duplex and half-duplex communications. In particular, by configuring sub-BWP channel configurations at a UE 115, techniques described herein may enable the UE 115 to switch between a full-duplex communication mode and a half-duplex communication mode without performing BWP switching. Moreover, sub-BWP channel configurations may provide improved granularity of uplink/downlink communication resources as compared to BWP channel configurations. Accordingly, by configuring UEs 115 with sub-BWP channel configurations, techniques of the present disclosure may improve resource utilization in the context of both full-duplex communications and half-duplex communications.

In some examples, the communications manager 1220 may be configured to perform various operations (for example, receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of techniques for sub-BWP configurations usable for half-duplex communications and full-duplex communications as described herein, or the processor 1240 and the memory 1230 may be otherwise configured to perform or support such operations.

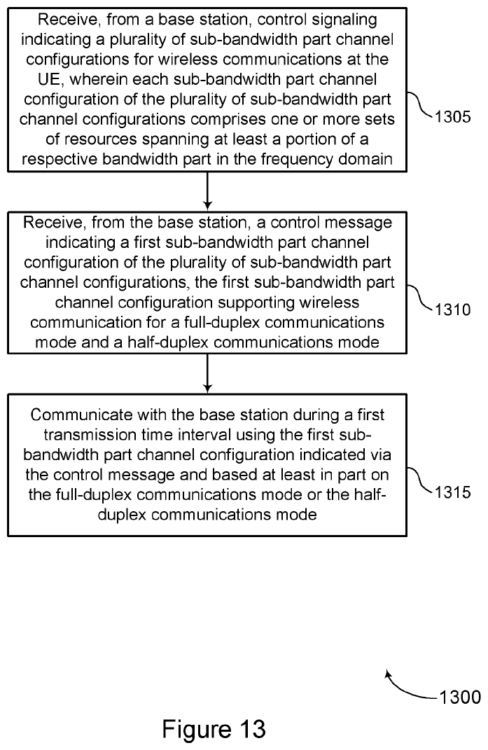

FIG. 13 shows a flowchart illustrating a method 1300 that supports techniques for sub-BWP configurations usable for half-duplex communications and full-duplex communications in accordance with aspects of the present disclosure. The operations of the method 1300 may be implemented by a UE or its components as described herein. For example, the operations of the method 1300 may be performed by a UE 115 as described with reference to FIGS. 1-8. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, control signaling indicating a set of multiple sub-BWP channel configurations for wireless communications at the UE, where each sub-BWP channel configuration of the set of multiple sub-BWP channel configurations includes one or more sets of resources spanning at least a portion of a respective BWP in the frequency domain. The operations of 1305 may be performed in accordance with examples as disclosed herein. In some examples, aspects of the operations of 1305 may be performed by a control signaling receiving manager 725 as described with reference to FIG. 7.

At 1310, the method may include receiving, from the base station, a control message indicating a first sub-BWP channel configuration of the set of multiple sub-BWP channel configurations, the first sub-BWP channel configuration supporting wireless communication for a full-duplex communication mode and a half-duplex communication mode. The operations of 1310 may be performed in accordance with examples as disclosed herein. In some examples, aspects of the operations of 1310 may be performed by a sub-BWP channel configuration manager 730 as described with reference to FIG. 7.

At 1315, the method may include communicating with the base station during a first TTI using the first sub-BWP channel configuration indicated via the control message and based on the full-duplex communication mode or the half-duplex communication mode. The operations of 1315 may be performed in accordance with examples as disclosed herein. In some examples, aspects of the operations of 1315 may be performed by a base station communicating manager 735 as described with reference to FIG. 7.

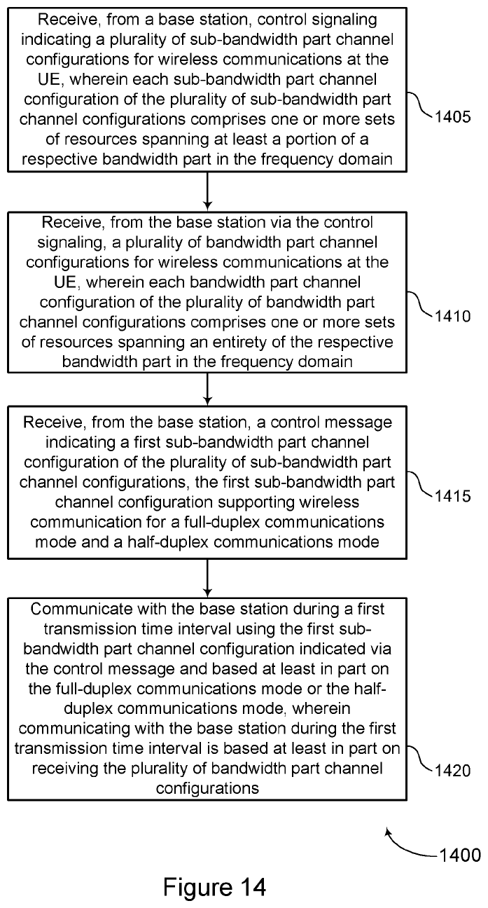

FIG. 14 shows a flowchart illustrating a method 1400 that supports techniques for sub-BWP configurations usable for half-duplex communications and full-duplex communications in accordance with aspects of the present disclosure. The operations of the method 1400 may be implemented by a UE or its components as described herein. For example, the operations of the method 1400 may be performed by a UE 115 as described with reference to FIGS. 1-8. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, control signaling indicating a set of multiple sub-BWP channel configurations for wireless communications at the UE, where each sub-BWP channel configuration of the set of multiple sub-BWP channel configurations includes one or more sets of resources spanning at least a portion of a respective BWP in the frequency domain. The operations of 1405 may be performed in accordance with examples as disclosed herein. In some examples, aspects of the operations of 1405 may be performed by a control signaling receiving manager 725 as described with reference to FIG. 7.

At 1410, the method may include receiving, from the base station via the control signaling, a set of multiple BWP channel configurations for wireless communications at the UE, where each BWP channel configuration of the set of multiple BWP channel configurations includes one or more sets of resources spanning an entirety of the respective BWP in the frequency domain. The operations of 1410 may be performed in accordance with examples as disclosed herein. In some examples, aspects of the operations of 1410 may be performed by a control signaling receiving manager 725 as described with reference to FIG. 7.

At 1415, the method may include receiving, from the base station, a control message indicating a first sub-BWP channel configuration of the set of multiple sub-BWP channel configurations, the first sub-BWP channel configuration supporting wireless communication for a full-duplex communication mode and a half-duplex communication mode. The operations of 1415 may be performed in accordance with examples as disclosed herein. In some examples, aspects of the operations of 1415 may be performed by a sub-BWP channel configuration manager 730 as described with reference to FIG. 7.

At 1420, the method may include communicating with the base station during a first TTI using the first sub-BWP channel configuration indicated via the control message and based on the full-duplex communication mode or the half-duplex communication mode, where communicating with the base station during the first TTI is based on receiving the set of multiple BWP channel configurations. The operations of 1420 may be performed in accordance with examples as disclosed herein. In some examples, aspects of the operations of 1420 may be performed by a base station communicating manager 735 as described with reference to FIG. 7.

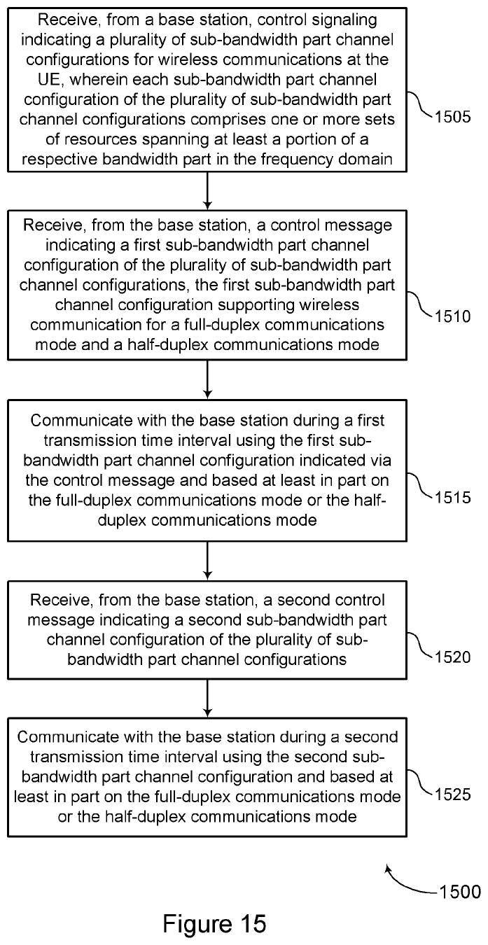

FIG. 15 shows a flowchart illustrating a method 1500 that supports techniques for sub-BWP configurations usable for half-duplex communications and full-duplex communications in accordance with aspects of the present disclosure. The operations of the method 1500 may be implemented by a UE or its components as described herein. For example, the operations of the method 1500 may be performed by a UE 115 as described with reference to FIGS. 1-8. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, control signaling indicating a set of multiple sub-BWP channel configurations for wireless communications at the UE, where each sub-BWP channel configuration of the set of multiple sub-BWP channel configurations includes one or more sets of resources spanning at least a portion of a respective BWP in the frequency domain. The operations of 1505 may be performed in accordance with examples as disclosed herein. In some examples, aspects of the operations of 1505 may be performed by a control signaling receiving manager 725 as described with reference to FIG. 7.

At 1510, the method may include receiving, from the base station, a control message indicating a first sub-BWP channel configuration of the set of multiple sub-BWP channel configurations, the first sub-BWP channel configuration supporting wireless communication for a full-duplex communication mode and a half-duplex communication mode. The operations of 1510 may be performed in accordance with examples as disclosed herein. In some examples, aspects of the operations of 1510 may be performed by a sub-BWP channel configuration manager 730 as described with reference to FIG. 7.

At 1515, the method may include communicating with the base station during a first TTI using the first sub-BWP channel configuration indicated via the control message and based on the full-duplex communication mode or the half-duplex communication mode. The operations of 1515 may be performed in accordance with examples as disclosed herein. In some examples, aspects of the operations of 1515 may be performed by a base station communicating manager 735 as described with reference to FIG. 7.

At 1520, the method may include receiving, from the base station, a second control message indicating a second sub-BWP channel configuration of the set of multiple sub-BWP channel configurations. The operations of 1520 may be performed in accordance with examples as disclosed herein. In some examples, aspects of the operations of 1520 may be performed by a sub-BWP channel configuration manager 730 as described with reference to FIG. 7.

At 1525, the method may include communicating with the base station during a second TTI using the second sub-BWP channel configuration and based on the full-duplex communication mode or the half-duplex communication mode. The operations of 1525 may be performed in accordance with examples as disclosed herein. In some examples, aspects of the operations of 1525 may be performed by a base station communicating manager 735 as described with reference to FIG. 7.

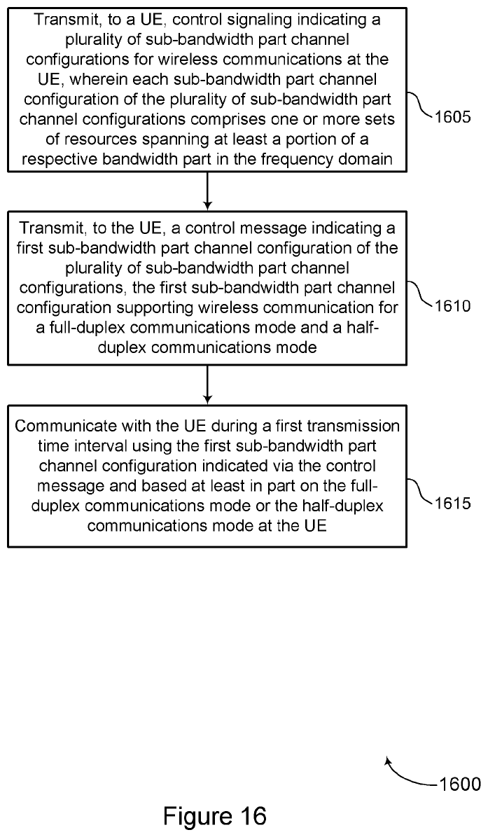

FIG. 16 shows a flowchart illustrating a method 1600 that supports techniques for sub-BWP configurations usable for half-duplex communications and full-duplex communications in accordance with aspects of the present disclosure. The operations of the method 1600 may be implemented by a base station or its components as described herein. For example, the operations of the method 1600 may be performed by a base station 105 as described with reference to FIGS. 1-4 and 9-12. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, control signaling indicating a set of multiple sub-BWP channel configurations for wireless communications at the UE, where each sub-BWP channel configuration of the set of multiple sub-BWP channel configurations includes one or more sets of resources spanning at least a portion of a respective BWP in the frequency domain. The operations of 1605 may be performed in accordance with examples as disclosed herein. In some examples, aspects of the operations of 1605 may be performed by a control signaling transmitting manager 1125 as described with reference to FIG. 11.

At 1610, the method may include transmitting, to the UE, a control message indicating a first sub-BWP channel configuration of the set of multiple sub-BWP channel configurations, the first sub-BWP channel configuration supporting wireless communication for a full-duplex communication mode and a half-duplex communication mode. The operations of 1610 may be performed in accordance with examples as disclosed herein. In some examples, aspects of the operations of 1610 may be performed by a sub-BWP channel configuration manager 1130 as described with reference to FIG. 11.

At 1615, the method may include communicating with the UE during a first TTI using the first sub-BWP channel configuration indicated via the control message and based on the full-duplex communication mode or the half-duplex communication mode at the UE. The operations of 1615 may be performed in accordance with examples as disclosed herein. In some examples, aspects of the operations of 1615 may be performed by a UE communicating manager 1135 as described with reference to FIG. 11.

The following provides an overview of aspects of the present disclosure:

Aspect 1: A method for wireless communication at a UE, comprising: receiving, from a base station, control signaling indicating a plurality of sub-BWP channel configurations for wireless communications at the UE, wherein each sub-BWP channel configuration of the plurality of sub-BWP channel configurations comprises one or more sets of resources spanning at least a portion of a respective BWP in the frequency domain; receiving, from the base station, a control message indicating a first sub-BWP channel configuration of the plurality of sub-BWP channel configurations, the first sub-BWP channel configuration supporting wireless communication for a full-duplex communication mode and a half-duplex communication mode; and communicating with the base station during a first TTI using the first sub-BWP channel configuration indicated via the control message and based at least in part on the full-duplex communication mode or the half-duplex communication mode.

Aspect 2: The method of aspect 1, further comprising: receiving, from the base station via the control signaling, a plurality of BWP channel configurations for wireless communications at the UE, wherein each BWP channel configuration of the plurality of BWP channel configurations comprises one or more sets of resources spanning an entirety of the respective BWP in the frequency domain, wherein communicating with the base station during the first TTI is based at least in part on receiving the plurality of BWP channel configurations.

Aspect 3: The method of aspect 2, wherein communicating with the base station during the first TTI is based at least in part on the full-duplex communication mode, the method further comprising: receiving, from the base station, an indication to perform communications in accordance with the half-duplex communication mode; and communicating with the base station during a second TTI using a BWP channel configuration of the plurality of BWP channel configurations and in accordance with the half-duplex communication mode based at least in part on receiving the indication to perform communications in accordance with the half-duplex communication mode.

Aspect 4: The method of any of aspects 1 through 3, wherein at least one sub-BWP channel configuration of the plurality of sub-BWP channel configurations comprises a set of resources spanning an entirety of the respective BWP in the frequency domain.

Aspect 5: The method of any of aspects 1 through 4, further comprising: receiving, from the base station, a second control message indicating a second sub-BWP channel configuration of the plurality of sub-BWP channel configurations; and communicating with the base station during a second TTI using the second sub-BWP channel configuration and based at least in part on the full-duplex communication mode or the half-duplex communication mode.

Aspect 6: The method of any of aspects 1 through 5, further comprising: receiving, from the base station via the control signaling, an indication of a first subset of the plurality of sub-BWP channel configurations that are associated with downlink communications at the UE and of a second subset of the plurality of sub-BWP channel configurations which are associated with uplink communications at the UE, wherein the first subset of the plurality of sub-BWP channel configurations, the second subset of the plurality of sub-BWP channel configurations, or both, are associated with the full-duplex communication mode, the half-duplex communication mode, or both.

Aspect 7: The method of any of aspects 1 through 6, wherein the first sub-BWP channel configuration is associated with downlink communications at the UE, wherein communicating with the base station during the first TTI comprises: receiving a first downlink transmission from the base station during the first TTI using the first sub-BWP channel configuration and based at least in part on the full-duplex communication mode; and transmitting a first uplink transmission to the base station during the first TTI using a second sub-BWP channel configuration associated with uplink communications at the UE and based at least in part on the full-duplex communication mode.

Aspect 8: The method of aspect 7, further comprising: receiving an indication to switch from the first sub-BWP channel configuration to a third sub-BWP channel configuration associated with downlink communications at the UE; receiving a second downlink transmission from the base station during a second TTI using the third sub-BWP channel configuration and based at least in part on the full-duplex communication mode; and transmitting a second uplink transmission to the base station during the first TTI using the second sub-BWP channel configuration and based at least in part on the full-duplex communication mode.

Aspect 9: The method of any of aspects 1 through 8, wherein each sub-BWP channel configuration of the plurality of sub-BWP channel configurations comprises one of a dedicated sub-BWP channel configuration, a dormant sub-BWP channel configuration, a default sub-BWP channel configuration, or a first active sub-BWP channel configuration, and wherein each sub-BWP channel configuration of the plurality of sub-BWP channel configurations is associated with one of a dedicated BWP, a default BWP, or a first active BWP

Aspect 10: The method of any of aspects 1 through 9, further comprising: receiving, from the base station, an RRC message indicating a first active BWP channel configuration associated with the full-duplex communication mode, wherein communicating with the base station during the first TTI comprises communicating in accordance with the first active BWP channel configuration and the full-duplex communication mode based at least in part on performing an RRC configuration procedure, performing an RRC reconfiguration procedure, or activating a SCell.

Aspect 11: The method of aspect 10, further comprising: receiving, from the base station via the control signaling, an indication of a first active sub-BWP channel configuration of the plurality of sub-BWP channel configurations that is associated with the first active BWP channel configuration, wherein communicating with the base station using the first active BWP channel configuration comprises communicating with the base station using the first active sub-BWP channel configuration.

Aspect 12: The method of any of aspects 1 through 11, wherein communicating with the base station during the first TTI is based at least in part on the full-duplex communication mode, the method further comprising: communicating with the base station during a second TTI using a first active BWP channel configuration associated with the half-duplex communication mode based at least in part on an absence of an additional first active BWP channel configuration that is associated with the full-duplex communication mode and based at least in part on performing an RRC configuration procedure, performing an RRC reconfiguration procedure, or activating a SCell.

Aspect 13: The method of any of aspects 1 through 12, further comprising: initiating an inactivity timer associated with the full-duplex communication mode; and communicating with the base station during the first TTI using the first sub-BWP channel configuration and in accordance with the full-duplex communication mode based at least in part on initiating the inactivity timer.

Aspect 14: The method of aspect 13, further comprising: communicating with the base station during an additional TTI before the first TTI based at least in part on the half-duplex communication mode; receiving, from the base station, an indication to transition from the half-duplex communication mode to the full-duplex communication mode, wherein initiating the inactivity timer is based at least in part on the indication to transition from the half-duplex communication mode to the full-duplex communication mode.

Aspect 15: The method of any of aspects 13 through 14, further comprising: determining an expiration of the inactivity timer based at least in part on a duration of the inactivity timer and based at least in part on an absence of communications performed in accordance with the full-duplex communication mode within the duration of the inactivity timer; transitioning from the full-duplex communication mode to the half-duplex communication mode based at least in part on the expiration of the inactivity timer; and communicating with the base station during a second TTI after the first TTI in accordance with the half-duplex communication mode and based at least in part on transitioning from the full-duplex communication mode to the half-duplex communication mode.

Aspect 16: The method of any of aspects 1 through 15, wherein communicating during the first TTI comprises communicating based at least in part on the full-duplex communication mode, the method further comprising: determining an expiration of an inactivity timer associated with the full-duplex communication mode; and communicating with the base station during a second TTI after the first TTI using the first sub-BWP channel configuration and based at least in part on the half-duplex communication mode based at least in part on the expiration of the inactivity timer, or using a second sub-BWP channel configuration and the half-duplex communication mode based at least in part on the expiration of the inactivity timer.

Aspect 17: The method of any of aspects 1 through 16, further comprising: transmitting, to the base station, a UE capability indication associated with the full-duplex communication mode at the UE, wherein receiving the control signaling, receiving the control message, communicating during the first TTI, or any combination thereof, is based at least in part on transmitting the UE capability indication.

Aspect 18: The method of aspect 17, wherein the UE capability indication comprises a first capability of the UE to perform communications according to the full-duplex communication mode, a second capability of the UE to switch between the half-duplex communication mode and the full-duplex communication mode, a third capability of the UE to perform full-duplex communications according to an inactivity timer, a fourth capability of the UE to perform full-duplex communications using a first active BWP channel configuration, a fifth capability of the UE to perform full-duplex communications using a first active sub-BWP channel configuration, or any combination thereof.

Aspect 19: A method for wireless communication at a base station, comprising: transmitting, to a UE, control signaling indicating a plurality of sub-BWP channel configurations for wireless communications at the UE, wherein each sub-BWP channel configuration of the plurality of sub-BWP channel configurations comprises one or more sets of resources spanning at least a portion of a respective BWP in the frequency domain; transmitting, to the UE, a control message indicating a first sub-BWP channel configuration of the plurality of sub-BWP channel configurations, the first sub-BWP channel configuration supporting wireless communication for a full-duplex communication mode and a half-duplex communication mode; and communicating with the UE during a first TTI using the first sub-BWP channel configuration indicated via the control message and based at least in part on the full-duplex communication mode or the half-duplex communication mode.

Aspect 20: The method of aspect 19, further comprising: transmitting, to the UE via the control signaling, a plurality of BWP channel configurations for wireless communications at the UE, wherein each BWP channel configuration of the plurality of BWP channel configurations comprises one or more sets of resources spanning an entirety of the respective BWP in the frequency domain, wherein communicating with the UE during the first TTI is based at least in part on transmitting the plurality of BWP channel configurations.

Aspect 21: The method of aspect 20, wherein communicating with the UE during the first TTI is in accordance with the full-duplex communication mode at the UE, the method further comprising: transmitting, to the UE, an indication to perform communications in accordance with the half-duplex communication mode; and communicating with the UE during a second TTI using a BWP channel configuration of the plurality of BWP channel configurations and in accordance with the half-duplex communication mode based at least in part on transmitting the indication to perform communications in accordance with the half-duplex communication mode.

Aspect 22: The method of any of aspects 19 through 21, wherein at least one sub-BWP channel configuration of the plurality of sub-BWP channel configurations comprises a set of resources spanning an entirety of the respective BWP in the frequency domain.

Aspect 23: The method of any of aspects 19 through 22, further comprising: transmitting, to the UE, a second control message indicating a second sub-BWP channel configuration of the plurality of sub-BWP channel configurations; and communicating with the UE during a second TTI using the second sub-BWP channel configuration and based at least in part on the full-duplex communication mode or the half-duplex communication mode.

Aspect 24: The method of any of aspects 19 through 23, further comprising: transmitting, to the UE via the control signaling, an indication of a first subset of the plurality of sub-BWP channel configurations that are associated with downlink communications at the UE and of a second subset of the plurality of sub-BWP channel configurations which are associated with uplink communications at the UE, wherein the first subset of the plurality of sub-BWP channel configurations, the second subset of the plurality of sub-BWP channel configurations, or both, are associated with the full-duplex communication mode, the half-duplex communication mode, or both.

Aspect 25: The method of any of aspects 19 through 24, wherein the first sub-BWP channel configuration is associated with downlink communications at the UE, wherein communicating with the UE during the first TTI comprises: transmitting a first downlink transmission to the UE during the first TTI using the first sub-BWP channel configuration and based at least in part on the full-duplex communication mode; and receiving a first uplink transmission from the UE during the first TTI using a second sub-BWP channel configuration associated with uplink communications at the UE and based at least in part on the full-duplex communication mode.

Aspect 26: The method of aspect 25, further comprising: transmitting an indication to switch from the first sub-BWP channel configuration to a third sub-BWP channel configuration associated with downlink communications at the UE; transmitting a second downlink transmission to the UE during a second TTI using the third sub-BWP channel configuration and based at least in part on the full-duplex communication mode; and receiving a second uplink transmission from the UE during the first TTI using the second sub-BWP channel configuration and based at least in part on the full-duplex communication mode.

Aspect 27: The method of any of aspects 19 through 26, wherein each sub-BWP channel configuration of the plurality of sub-BWP channel configurations comprises one of a dedicated sub-BWP channel configuration, a dormant sub-BWP channel configuration, a default sub-BWP channel configuration, or a first active sub-BWP channel configuration, and wherein each sub-BWP channel configuration of the plurality of sub-BWP channel configurations is associated with one of a dedicated BWP, a default BWP, or a first active BWP

Aspect 28: The method of any of aspects 19 through 27, further comprising: transmitting, to the UE, an RRC message indicating a first active BWP channel configuration associated with the full-duplex communication mode, wherein communicating with the UE during the first TTI comprises communicating using the first active BWP channel configuration and based at least in part on the full-duplex communication mode.

Aspect 29: The method of aspect 28, further comprising: transmitting, to the UE via the control signaling, an indication of a first active sub-BWP channel configuration of the plurality of sub-BWP channel configurations that is associated with the first active BWP channel configuration, wherein communicating with the UE using the first active BWP channel configuration comprises communicating with the UE using the first active sub-BWP channel configuration.

Aspect 30: The method of any of aspects 19 through 29, wherein communicating with the UE during the first TTI is based at least in part on the full-duplex communication mode, the method further comprising: communicating with the UE during a second TTI using a first active BWP channel configuration associated with the half-duplex communication mode based at least in part on an absence of an additional first active BWP channel configuration that is associated with the full-duplex communication mode.

Aspect 31: The method of any of aspects 19 through 30, further comprising: initiating an inactivity timer associated with the full-duplex communication mode at the UE; and communicating with the UE during the first TTI using the first sub-BWP channel configuration and based at least in part on the full-duplex communication mode based at least in part on initiating the inactivity timer.

Aspect 32: The method of aspect 31, further comprising: communicating with the UE during an additional TTI before the first TTI based at least in part on the half-duplex communication mode; transmitting, to the UE, an indication to transition from the half-duplex communication mode to the full-duplex communication mode, wherein initiating the inactivity timer is based at least in part on the indication to transition from the half-duplex communication mode to the full-duplex communication mode.

Aspect 33: The method of any of aspects 31 through 32, further comprising: determining an expiration of the inactivity timer based at least in part on a duration of the inactivity timer and based at least in part on an absence of communications performed at the UE in accordance with the full-duplex communication mode within the duration of the inactivity timer; and communicating with the UE during a second TTI after the first TTI in accordance with the half-duplex communication mode and based at least in part on the UE transitioning from the full-duplex communication mode to the half-duplex communication mode.

Aspect 34: The method of any of aspects 19 through 33, wherein communicating during the first TTI comprises communicating in accordance with the full-duplex communication mode at the UE, the method further comprising: determining an expiration of an inactivity timer associated with the full-duplex communication mode; and communicating with the UE during a second TTI after the first TTI using the first sub-BWP channel configuration and in accordance with the half-duplex communication mode based at least in part on the expiration of the inactivity timer, or in accordance with a second sub-BWP channel configuration and the half-duplex communication mode based at least in part on the expiration of the inactivity timer.

Aspect 35: The method of any of aspects 19 through 34, further comprising: receiving, from the UE, a UE capability indication associated with the full-duplex communication mode at the UE, wherein transmitting the control signaling, transmitting the control message, communicating during the first TTI, or any combination thereof, is based at least in part on receiving the UE capability indication.

Aspect 36: The method of aspect 35, wherein the UE capability indication comprises a first capability of the UE to perform communications according to the full-duplex communication mode, a second capability of the UE to switch between the half-duplex communication mode and the full-duplex communication mode, a third capability of the UE to perform full-duplex communications according to an inactivity timer, a fourth capability of the UE to perform full-duplex communications using a first active BWP channel configuration, a fifth capability of the UE to perform full-duplex communications using a first active sub-BWP channel configuration, or any combination thereof.

Aspect 37: An apparatus for wireless communication at a UE, comprising a processor; memory coupled with the processor; and instructions stored in the memory and executable by the processor to cause the apparatus to perform a method of any of aspects 1 through 18.

Aspect 38: An apparatus for wireless communication at a UE, comprising at least one means for performing a method of any of aspects 1 through 18.

Aspect 39: A non-transitory computer-readable medium storing code for wireless communication at a UE, the code comprising instructions executable by a processor to perform a method of any of aspects 1 through 18.

Aspect 40: An apparatus for wireless communication at a base station, comprising a processor; memory coupled with the processor; and instructions stored in the memory and executable by the processor to cause the apparatus to perform a method of any of aspects 19 through 36.

Aspect 41: An apparatus for wireless communication at a base station, comprising at least one means for performing a method of any of aspects 19 through 36.

Aspect 42: A non-transitory computer-readable medium storing code for wireless communication at a base station, the code comprising instructions executable by a processor to perform a method of any of aspects 19 through 36.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a base station, control signaling indicating a plurality of sub-bandwidth part channel configurations for wireless communications at the UE, each sub-bandwidth part channel configuration of the plurality of sub-bandwidth part channel configurations comprising one or more sets of resources spanning at least a portion of a respective bandwidth part in the frequency domain;
receiving, from the base station, a control message indicating a first sub-bandwidth part channel configuration of the plurality of sub-bandwidth part channel configurations, the first sub-bandwidth part channel configuration supporting wireless communication for a full-duplex communication mode and a half-duplex communication mode; and
communicating with the base station during a first transmission time interval using the first sub-bandwidth part channel configuration and based at least in part on the full-duplex communication mode or the half-duplex communication mode.

2. The method of claim 1, further comprising:
receiving, from the base station via the control signaling, a plurality of bandwidth part channel configurations for wireless communications at the UE, wherein each bandwidth part channel configuration of the plurality of bandwidth part channel configurations comprises one or more sets of resources spanning an entirety of the respective bandwidth part in the frequency domain, wherein communicating with the base station during the first transmission time interval is based at least in part on receiving the plurality of bandwidth part channel configurations.

3. The method of claim 2, wherein communicating with the base station during the first transmission time interval is based at least in part on the full-duplex communication mode, the method further comprising:
receiving, from the base station, an indication to perform communications in accordance with the half-duplex communication mode; and
communicating with the base station during a second transmission time interval using a bandwidth part channel configuration of the plurality of bandwidth part channel configurations and in accordance with the half-duplex communication mode based at least in part on receiving the indication to perform communications in accordance with the half-duplex communication mode.

4. The method of claim 1, wherein at least one sub-bandwidth part channel configuration of the plurality of sub-bandwidth part channel configurations comprises a set of resources spanning the entire bandwidth part in the frequency domain.

5. The method of claim 1, further comprising:
receiving, from the base station, a second control message indicating a second sub-bandwidth part channel configuration of the plurality of sub-bandwidth part channel configurations; and
communicating with the base station during a second transmission time interval using the second sub-bandwidth part channel configuration and based at least in part on the full-duplex communication mode or the half-duplex communication mode.

6. The method of claim 1, further comprising:
receiving, from the base station via the control signaling, an indication of a first subset of the plurality of sub-bandwidth part channel configurations that are associated with downlink communications at the UE and of a second subset of the plurality of sub-bandwidth part channel configurations which are associated with uplink communications at the UE, wherein the first subset of the plurality of sub-bandwidth part channel configurations, the second subset of the plurality of sub-bandwidth part channel configurations, or both, are associated with the full-duplex communication mode, the half-duplex communication mode, or both.

7. The method of claim 1, wherein the first sub-bandwidth part channel configuration is associated with downlink communications at the UE, wherein communicating with the base station during the first transmission time interval comprises:
receiving a first downlink transmission from the base station during the first transmission time interval using the first sub-bandwidth part channel configuration and based at least in part on the full-duplex communication mode; and
transmitting a first uplink transmission to the base station during the first transmission time interval using a second sub-bandwidth part channel configuration associated with uplink communications at the UE and based at least in part on the full-duplex communication mode.

8. The method of claim 7, further comprising:
receiving an indication to switch from the first sub-bandwidth part channel configuration to a third sub-bandwidth part channel configuration associated with downlink communications at the UE;
receiving a second downlink transmission from the base station during a second transmission time interval using the third sub-bandwidth part channel configuration and based at least in part on the full-duplex communication mode; and
transmitting a second uplink transmission to the base station during the second transmission time interval using the second sub-bandwidth part channel configuration and based at least in part on the full-duplex communication mode.

9. The method of claim 1, wherein:
each sub-bandwidth part channel configuration of the plurality of sub-bandwidth part channel configurations comprises one of a dedicated sub-bandwidth part channel configuration, a dormant sub-bandwidth part channel configuration, a default sub-bandwidth part channel configuration, or a first active sub-bandwidth part channel configuration, and each sub-bandwidth part channel configuration of the plurality of sub-bandwidth part channel configurations is associated with one of a dedicated bandwidth part, a default bandwidth part, or a first active bandwidth part.

10. The method of claim 1, further comprising:
receiving, from the base station, a radio resource control message indicating a first active bandwidth part channel configuration associated with the full-duplex communication mode, wherein communicating with the base station during the first transmission time interval comprises communicating using the first active bandwidth part channel configuration and the full-duplex communication mode based at least in part on performing a radio resource control configuration procedure, performing a radio resource control reconfiguration procedure, or activating a secondary cell.

11. The method of claim 10, further comprising:
receiving, from the base station via the control signaling, an indication of a first active sub-bandwidth part channel configuration of the plurality of sub-bandwidth part channel configurations that is associated with the first active bandwidth part channel configuration, wherein communicating with the base station using the first active bandwidth part channel configuration comprises communicating with the base station using the first active sub-bandwidth part channel configuration.

12. The method of claim 1, wherein communicating with the base station during the first transmission time interval is performed based at least in part on the full-duplex communication mode, the method further comprising:
communicating with the base station during a second transmission time interval using a first active bandwidth part channel configuration associated with the half-duplex communication mode based at least in part on an absence of an additional first active bandwidth part channel configuration that is associated with the full-duplex communication mode and based at least in part on performing a radio resource control configuration procedure, performing a radio resource control reconfiguration procedure, or activating a secondary cell.

13. The method of claim 1, further comprising:
initiating an inactivity timer associated with the full-duplex communication mode; and
communicating with the base station during the first transmission time interval using the first sub-bandwidth part channel configuration and in accordance with the full-duplex communication mode based at least in part on initiating the inactivity timer.

14. The method of claim 13, further comprising:
communicating with the base station during an additional transmission time interval before the first transmission time interval based at least in part on the half-duplex communication mode; and
receiving, from the base station, an indication to transition from the half-duplex communication mode to the full-duplex communication mode, wherein initiating the inactivity timer is based at least in part on the indication to transition from the half-duplex communication mode to the full-duplex communication mode.

15. The method of claim 13, further comprising:
determining an expiration of the inactivity timer based at least in part on a duration of the inactivity timer and based at least in part on an absence of communications performed in accordance with the full-duplex communication mode within the duration of the inactivity timer;
transitioning from the full-duplex communication mode to the half-duplex communication mode based at least in part on the expiration of the inactivity timer; and
communicating with the base station during a second transmission time interval after the first transmission time interval in accordance with the half-duplex communication mode and based at least in part on transitioning from the full-duplex communication mode to the half-duplex communication mode.

16. The method of claim 1, wherein communicating during the first transmission time interval comprises communicating based at least in part on the full-duplex communication mode, the method further comprising:
communicating with the base station during a second transmission time interval after the first transmission time interval using the first sub-bandwidth part channel configuration and the half-duplex communication mode based at least in part on an expiration of an inactivity timer associated with the full-duplex communication mode, or using a second sub-bandwidth part channel configuration and the half-duplex communication mode based at least in part on the expiration of the inactivity timer.

17. The method of claim 1, further comprising:
transmitting, to the base station, a UE capability indication associated with the full-duplex communication mode at the UE, wherein receiving the control signaling, receiving the control message, communicating during the first transmission time interval, or any combination thereof, is based at least in part on transmitting the UE capability indication.

18. The method of claim 17, wherein the UE capability indication comprises a first capability of the UE to perform communications according to the full-duplex communication mode, a second capability of the UE to switch between the half-duplex communication mode and the full-duplex communication mode, a third capability of the UE to perform full-duplex communications according to an inactivity timer, a fourth capability of the UE to perform full-duplex communications using a first active bandwidth part channel configuration, a fifth capability of the UE to perform full-duplex communications using a first active sub-bandwidth part channel configuration, or any combination thereof.

19. A method for wireless communication at a base station, comprising:
transmitting, to a user equipment (UE), control signaling indicating a plurality of sub-bandwidth part channel configurations for wireless communications at the UE, each sub-bandwidth part channel configuration of the plurality of sub-bandwidth part channel configurations comprising one or more sets of resources spanning at least a portion of a respective bandwidth part in the frequency domain;
transmitting, to the UE, a control message indicating a first sub-bandwidth part channel configuration of the plurality of sub-bandwidth part channel configurations, the first sub-bandwidth part channel configuration supporting wireless communication for a full-duplex communication mode and a half-duplex communication mode; and
communicating with the UE during a first transmission time interval using the first sub-bandwidth part channel configuration indicated via the control message and based at least in part on the full-duplex communication mode or the half-duplex communication mode at the UE.

20. The method of claim 19, further comprising:
transmitting, to the UE via the control signaling, a plurality of bandwidth part channel configurations for wireless communications at the UE, wherein each bandwidth part channel configuration of the plurality of bandwidth part channel configurations comprises one or more sets of resources spanning an entirety of the respective bandwidth part in the frequency domain, wherein communicating with the UE during the first transmission time interval is based at least in part on transmitting the plurality of bandwidth part channel configurations.

21. The method of claim 20, wherein communicating with the UE during the first transmission time interval is based at least in part on the full-duplex communication mode, the method further comprising:
transmitting, to the UE, an indication to perform communications in accordance with the half-duplex communication mode; and
communicating with the UE during a second transmission time interval using a bandwidth part channel configuration of the plurality of bandwidth part channel configurations and in accordance with the half-duplex communication mode based at least in part on transmitting the indication to perform communications in accordance with the half-duplex communication mode.

22. The method of claim 19, further comprising:
transmitting, to the UE, a second control message indicating a second sub-bandwidth part channel configuration of the plurality of sub-bandwidth part channel configurations; and
communicating with the UE during a second transmission time interval using the second sub-bandwidth part channel configuration and based at least in part on the full-duplex communication mode or the half-duplex communication mode.

23. An apparatus for wireless communication at a user equipment (UE), comprising:
a processor; and
memory coupled with the processor and storing instructions executable by the processor to cause the apparatus to:
receive, from a base station, control signaling indicating a plurality of sub-bandwidth part channel configurations for wireless communications at the UE, each sub-bandwidth part channel configuration of the plurality of sub-bandwidth part channel configurations comprising one or more sets of resources spanning at least a portion of a respective bandwidth part in the frequency domain;
receive, from the base station, a control message indicating a first sub-bandwidth part channel configuration of the plurality of sub-bandwidth part channel configurations, the first sub-bandwidth part channel configuration supporting wireless communication for a full-duplex communication mode and a half-duplex communication mode; and
communicate with the base station during a first transmission time interval using the first sub-bandwidth part channel configuration indicated via the control message and based at least in part on the full-duplex communication mode or the half-duplex communication mode.

24. The apparatus of claim 23, wherein the instructions are further executable by the processor to cause the apparatus to:
receive, from the base station via the control signaling, a plurality of bandwidth part channel configurations for wireless communications at the UE, wherein each bandwidth part channel configuration of the plurality of bandwidth part channel configurations comprises one or more sets of resources spanning an entirety of the respective bandwidth part in the frequency domain, wherein communicating with the base station during the first transmission time interval is based at least in part on receiving the plurality of bandwidth part channel configurations.

25. The apparatus of claim 24, wherein communicating with the base station during the first transmission time interval is based at least in part on the full-duplex communication mode, wherein the instructions are further executable by the processor to cause the apparatus to:
receive, from the base station, an indication to perform communications in accordance with the half-duplex communication mode; and
communicate with the base station during a second transmission time interval using a bandwidth part channel configuration of the plurality of bandwidth part channel configurations and in accordance with the half-duplex communication mode based at least in part on receiving the indication to perform communications in accordance with the half-duplex communication mode.

26. The apparatus of claim 23, wherein the instructions are further executable by the processor to cause the apparatus to:
receive, from the base station, a second control message indicating a second sub-bandwidth part channel configuration of the plurality of sub-bandwidth part channel configurations; and
communicate with the base station during a second transmission time interval using the second sub-bandwidth part channel configuration and based at least in part on the full-duplex communication mode or the half-duplex communication mode.

27. An apparatus for wireless communication at a base station, comprising:
a processor; and
memory coupled with the processor and storing instructions executable by the processor to cause the apparatus to:
transmit, to a user equipment (UE), control signaling indicating a plurality of sub-bandwidth part channel configurations for wireless communications at the UE, each sub-bandwidth part channel configuration of the plurality of sub-bandwidth part channel configurations comprising one or more sets of resources spanning at least a portion of a respective bandwidth part in the frequency domain;
transmit, to the UE, a control message indicating a first sub-bandwidth part channel configuration of the plurality of sub-bandwidth part channel configurations, the first sub-bandwidth part channel configuration supporting wireless communication for a full-duplex communication mode and a half-duplex communication mode; and
communicate with the UE during a first transmission time interval using the first sub-bandwidth part channel configuration indicated via the control message and based at least in part on the full-duplex communication mode or the half-duplex communication mode at the UE.

28. The apparatus of claim 27, wherein the instructions are further executable by the processor to cause the apparatus to:
transmit, to the UE via the control signaling, a plurality of bandwidth part channel configurations for wireless communications at the UE, wherein each bandwidth part channel configuration of the plurality of bandwidth part channel configurations comprises one or more sets of resources spanning an entirety of the respective bandwidth part in the frequency domain, wherein communicating with the UE during the first transmission time interval is based at least in part on transmitting the plurality of bandwidth part channel configurations.

29. The apparatus of claim 28, wherein communicating with the UE during the first transmission time interval is based at least in part on the full-duplex communication mode, wherein the instructions are further executable by the processor to cause the apparatus to:
transmit, to the UE, an indication to perform communications in accordance with the half-duplex communication mode; and
communicate with the UE during a second transmission time interval using a bandwidth part channel configuration of the plurality of bandwidth part channel configurations and in accordance with the half-duplex communication mode based at least in part on transmitting the indication to perform communications in accordance with the half-duplex communication mode.

30. The apparatus of claim 27, wherein the instructions are further executable by the processor to cause the apparatus to:
transmit, to the UE, a second control message indicating a second sub-bandwidth part channel configuration of the plurality of sub-bandwidth part channel configurations; and
communicate with the UE during a second transmission time interval using the second sub-bandwidth part channel configuration and based at least in part on the full-duplex communication mode or the half-duplex communication mode.
